(19) United States
(12) Patent Application Publication
(10) Pub. No.: US 2026/0231066 A1
(43) Pub. Date: Aug. 6, 2026

(54) METHOD AND DEVICE FOR SUPPORTING SUBBAND FULL DUPLEX COMMUNICATION BY CONSIDERING TRANSMISSION OF SYNCHRONIZATION SIGNAL BLOCK

(71) Applicant: ELECTRONICS AND TELECOMMUNICATIONS RESEARCH INSTITUTE, Daejeon (KR)

(72) Inventors: Jung Hoon LEE, Daejeon (KR); Cheul Soon KIM, Daejeon (KR); Hoon Dong NOH, Daejeon (KR); Sung Hyun MOON, Daejeon (KR)

(21) Appl. No.: 19/147,101

(22) PCT Filed: Jan. 17, 2024
(86) PCT No.: PCT/KR2024/000856

§ 371 Date: Jul. 10, 2025

(30) Foreign Application Priority Data
Jan. 19, 2023 (KR) 10-2023-0008288
Feb. 14, 2023 (KR) 10-2023-0019565

(51) Int. Cl. H04W 56/00; H04B 7/06; H04L 5/00; H04L 5/14; H04L 27/26; H04W 76/20

(52) U.S. Cl. CPC H04W 56/0015; H04B 7/06968; H04L 5/0051; H04L 5/14; H04L 27/2605; H04W 76/20

(57) ABSTRACT

A method of a terminal may comprise the steps of: identifying an SSB time interval for SSB reception or measurement and a normal time interval that is not the SSB time interval; receiving or measuring at least one SSB in the SSB time interval; and transmitting at least one uplink signal or receiving at least one downlink signal in the normal time interval, wherein a subband full duplex (SBFD) operation is performed in the SSB time interval and the normal time interval, or the SBFD operation is not performed in the SSB time interval and is performed only in the normal time interval.

### TECHNICAL FIELD

The present disclosure relates to subband full-duplex communication, and more particularly, to a method and an apparatus for supporting subband full-duplex communication considering transmission of synchronization signal blocks.

### BACKGROUND ART

Duplex communication between communication nodes (e.g. base station and terminal) may be performed based on a half-duplex scheme or a full-duplex scheme. According to the full-duplex scheme, a communication node can perform transmission and reception operations simultaneously or at different times. Even in a time division duplex (TDD) system (e.g. systems using a TDD carrier, unpaired spectrum, etc.), a communication node can perform transmission and reception operations within a common frequency region (e.g. carrier commonly used for uplink and downlink transmissions), and if the transmission operation and the reception operation are performed simultaneously, a transmission signal may interfere with a reception signal. Therefore, self-interference cancellation techniques may be required to perform full-duplex communication in a TDD system.

In release-18 (Rel-18), the beginning of 5G-Advanced, researches are being conducted on full-duplex communication schemes to increase spectrum efficiency, improve uplink performance, and reduce latency. More specifically, a base station can perform both a transmission operation and a reception operation simultaneously, while a terminal can only perform either a transmission operation or a reception operation at one time. A sub-band full-duplex (SBFD) communication scheme is being studied in which frequency resources for uplink and downlink communications are separated from each other in a time period where simultaneous transmission of uplink and downlink signals between the terminal and the base station is allowed.

Even when communication is performed using the SBFD scheme, the terminal may have no or insufficient capability to cancel cross-link interference compared to the base station. Additionally, in case of terminals of previous releases (i.e. existing terminals, legacy UEs) that do not support the SBFD scheme, they may not have capabilities to cancel cross-link interference at all. Therefore, an SBFD communication method that considers a transmission period of synchronization signal blocks (SSBs), one of important downlink signals in a new radio (NR) communication system, is required.

### DISCLOSURE

### Technical Problem

The present disclosure is directed to providing a method and an apparatus for supporting subband full-duplex communication considering transmission of synchronization signal blocks.

### Technical Solution

According to a first exemplary embodiment of the present disclosure for achieving the above-described objective, a method of a terminal may comprise: identifying a synchronization signal block (SSB) time period for SSB reception or measurement and a general time period other than the SSB time period; receiving or measuring at least one SSB in the SSB time period; and transmitting at least one uplink signal or receiving at least one downlink signal in the general time period, wherein a subband full-duplex (SBFD) operation is performed in the SSB time period and the general time period, or the SBFD operation is not performed in the SSB time period and the SBFD operation is performed only in the general time period.

The SSB time period may be determined as an SSB burst set predefined by technical specifications, or may be determined as position(s) or section(s) where SSB(s) are actually transmitted within the SSB burst set or an SSB-based radio resource measurement (RRM) Measurement Timing Configuration (SMTC) window identified through remaining system information (RMSI) and/or user equipment (UE)-specific radio resource control (RRC) signaling received from the base station.

When SBFD operations are performed in the SSB time period, a first guard band for the SBFD operations applied to the SSB time period may be configured separately from a second guard band for the SBFD operations applied to the general time period.

When SBFD operations are performed in the SSB time period, an uplink transmission power for the SBFD operations applied to the SSB time period may be set separately from an uplink transmission power for the SBFD operations applied to the general time period.

The method may further comprise: receiving from the base station a list including at least one Transmission Configuration Indicator (TCI) or sounding reference signal (SRS) resource indicator (SRI) that is prohibited in the SSB time period, wherein when SBFD operations are performed in the SSB time period, the terminal may not perform uplink transmission to which the at least one TCI or SRI is applied during the SSB time period.

When the SSB time period is classified into a cell defining (CD)-SSB time period in which CD-SSB(s) are transmitted and/or a non-cell-defining (NCD)-SSB time period in which NCD-SSB(s) are transmitted, and SBFD operations are performed in the SSB time period, a first guard band for the SBFD operations applied to the CD-SSB time period may be configured separately from a second guard band for the SBFD operations applied to the NCD-SSB time period, or an uplink transmission power for the SBFD operations applied to the CD-SSB time period may be set separately from an uplink transmission power for the SBFD operations applied to the NCD-SSB time period.

According to a second exemplary embodiment of the present disclosure for achieving the above-described objective, a method of a terminal may comprise: receiving, from a base station, configuration information of a synchronization signal block (SSB) time period for SSB reception or measurement; receiving configuration information of subband full-duplex (SBFD) operations from the base station; determining whether to perform the SBFD operation in the SSB time period; and in response to determining to perform the SBFD operation in the SSB time period, performing the SBFD operation in the SSB time period.

The configuration information of the SSB time period may be received as SSB measurement window configuration information, or may be received based on the SSB measurement window configuration information and remaining system information (RMSI) and/or user equipment (UE)-specific radio resource control (RRC) signaling, the SSB time period may be determined as an SSB measurement window indicated by the SSB measurement window configuration information, or may be determined as position(s) or section(s) where SSB(s) are actually transmitted within the SSB measurement window, which are identified through the RMSI and/or UE-specific RRC signaling.

The method may further comprise: performing the SBFD operation in a general time period other than the SSB time period.

When the SBFD operation is performed in the SSB time period, first guard band(s) may be configured around an uplink resource belonging to a frequency region for performing the SBFD operation within the SSB time period.

A bandwidth of the first guard band(s) may be set separately from a bandwidth of second guard band(s) configured around an uplink resource belonging to a frequency region for performing the SBFD operation in a general time period that does not overlap with the SSB time period.

When an uplink transmission through an uplink resource including the first guard band(s) is scheduled, the terminal may drop the uplink transmission or may perform the uplink transmission using a resource excluding a resource belonging to the first guard band(s) from the uplink resource.

When the uplink transmission is performed in the resource excluding the resource belonging to the first guard band(s) from the uplink resource, the terminal may perform puncturing or rate-matching for uplink transmission data mapped to the resource belonging to the first guard band(s).

When the SBFD operation is performed in the SSB time period, a transmission power applied to an uplink resource belonging to a frequency region for performing the SBFD operation within the SSB time period may be set separately from a transmission power applied to an uplink resource belonging to a frequency region for performing the SBFD operation within a general time period that does not overlap the SSB time period.

The method may further comprise: receiving from the base station a list including at least one Transmission Configuration Indicator (TCI) or sounding reference signal (SRS) resource indicator (SRI) that is prohibited in the SSB time period, wherein when SBFD operations are performed in the SSB time period, the terminal may not perform uplink transmission to which the at least one TCI or SRI is applied during the SSB time period.

When the SSB time period is classified into a cell defining (CD)-SSB time period in which CD-SSB(s) are transmitted and/or a non-cell-defining (NCD)-SSB time period in which NCD-SSB(s) are transmitted, and SBFD operations are performed in the SSB time period, a first guard band for the SBFD operations applied to the CD-SSB time period may be configured separately from a second guard band for the SBFD operations applied to the NCD-SSB time period, or an uplink transmission power for the SBFD operations applied to the CD-SSB time period may be set separately from an uplink transmission power for the SBFD operations applied to the NCD-SSB time period.

According to a third exemplary embodiment of the present disclosure for achieving the above-described objective, a method of a terminal may comprise: receiving configuration information of a first synchronization signal block (SSB) measurement window from a base station; receiving configuration information of subband full-duplex (SBFD) operations from the base station; receiving configuration information of a second SSB measurement window from the base station; performing a measurement operation for SSB(s) in a first SSB time period belonging to the second SSB measurement window; and performing the SBFD operation in a time period that belongs to the first SSB measurement window and does not belong to the second SSB measurement window.

Each of the configuration information of the first SSB measurement window and the configuration information of the second SSB measurement window may be configuration information of an SSB-based radio resource measurement (RRM) Measurement Timing Configuration (SMTC) window.

The method may further comprise: determining whether to perform the SBFD operation in the first SSB time period, wherein the determining of whether to perform the SBFD operation in the first SSB time period may comprise: receiving, from the base station, information on position(s) where SSB(s) are actually transmitted among candidate SSB positions within the first SSB time period; determining to perform the SBFD operation at position(s) other than the position(s) where SSB(s) are actually transmitted among the candidate SSB positions within the first SSB time period; and in response to determining to perform the SBFD operation in the first SSB time period, performing the SBFD operation in the first SSB time period.

The information on the position(s) where SSB(s) are actually transmitted among the candidate SSB positions within the first SSB time period may be a parameter ssb-PositionsInBurst received from the base station through remaining system information (RMSI) and/or user equipment (UE)-specific radio resource control (RRC) signaling.

### Advantageous Effects

According to exemplary embodiments of the present disclosure, SBFD communication considering the transmission of SSBs can be performed. Therefore, cross-link interference on the reception of SSBs, important downlink signals, performed by other terminals, can be reduced, and resource efficiency through SBFD operations can also be maintained. Consequently, overall performance of the communication system can be enhanced.

### DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating a first exemplary embodiment of a type 1 frame.

FIG. 4 is a conceptual diagram illustrating a first exemplary embodiment of a type 2 frame.

FIG. 5 is a conceptual diagram illustrating a first exemplary embodiment of a transmission method of SS/PBCH block in a communication system.

FIG. 6 is a conceptual diagram illustrating a first exemplary embodiment of an SS/PBCH block in a communication system.

FIG. 7 is a conceptual diagram illustrating a second exemplary embodiment of a method of transmitting SS/PBCH blocks in a communication system.

FIG. 8 is a conceptual diagram for describing time domain transmission positions of SSBs according to a subcarrier spacing and L.

FIG. 9 is a conceptual diagram illustrating an example for indicating position(s) where SSB(s) are actually transmitted in an FR2 band through RMSI.

FIG. 10A is a conceptual diagram illustrating an RMSI CORESET mapping pattern #1 in a communication system, FIG. 10B is a conceptual diagram illustrating an RMSI CORESET mapping pattern #2 in a communication system, and FIG. 10C is a conceptual diagram illustrating an RMSI CORESET mapping pattern #3 in a communication system.

FIGS. 11A to 11C are diagrams for describing examples of various configurations of Type 0 CSS slots corresponding to SSB indexes.

FIG. 12 is a conceptual diagram illustrating a first exemplary embodiment of configuration of a slot in which a PSFCH is configured.

FIG. 13 is a conceptual diagram illustrating a first exemplary embodiment of a PSFCH for ACK/NACK transmission.

FIG. 14 is a conceptual diagram illustrating exemplary embodiments of a method for multiplexing a control channel and a data channel in sidelink communication.

FIG. 15 is a conceptual diagram illustrating a first exemplary embodiment of a resource selection operation.

FIG. 16 is a conceptual diagram illustrating a first exemplary embodiment of a resource reselection operation.

FIG. 17 is a conceptual diagram for describing in-band full-duplex communication.

FIG. 18 is a conceptual diagram illustrating an exemplary embodiment to describe a method of multiplexing an uplink signal and a downlink signal in full-duplex communication.

FIG. 19 is a conceptual diagram illustrating configuration of frequency regions for SBFD operations according to an exemplary embodiment of the present disclosure.

FIG. 20 is a conceptual diagram for describing a case where guard bands of different widths are configured in an SSB time period and a general time period according to an exemplary embodiment of the present disclosure.

FIG. 21 is a sequence chart for describing a method of performing an SBFD operation considering SSB transmission according to an exemplary embodiment of the present disclosure.

FIG. 22 is a sequence chart for describing a method of performing an SBFD operation considering SSB transmission according to another exemplary embodiment of the present disclosure.

### BEST MODE OF THE INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, ‘at least one of A and B’ may mean ‘at least one of A or B’ or ‘at least one of combinations of one or more of A and B’. Also, in exemplary embodiments of the present disclosure, ‘one or more of A and B’ may mean ‘one or more of A or B’ or ‘one or more of combinations of one or more of A and B’.

In exemplary embodiments of the present disclosure, ‘(re) transmission’ may mean ‘transmission’, ‘retransmission’, or ‘transmission and retransmission’, ‘(re) configuration’ may mean ‘configuration’, ‘reconfiguration’, or ‘configuration and reconfiguration’, ‘(re) connection’ may mean ‘connection’, ‘reconnection’, or ‘connection and reconnection’, and ‘(re-) access’ may mean ‘access’, ‘re-access’, or ‘access and re-access’.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

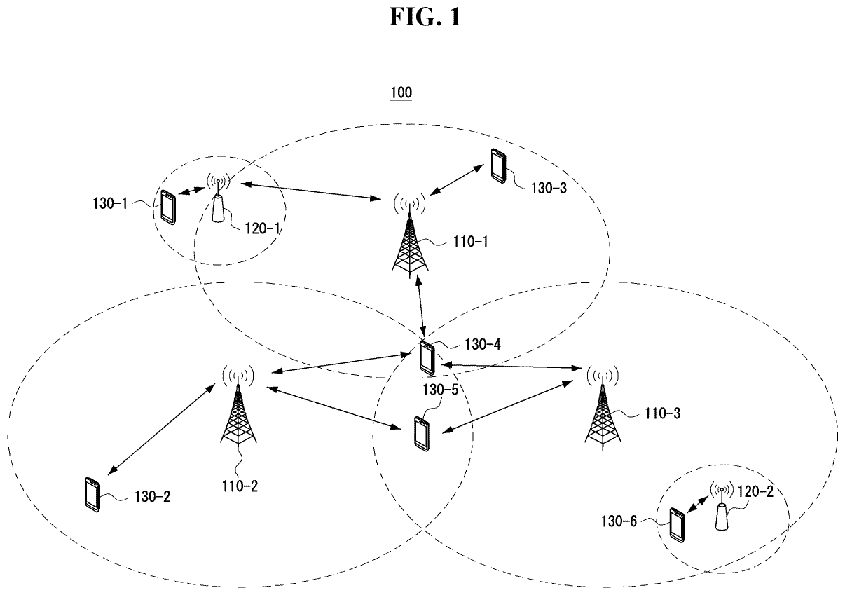

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further comprise a core network (e.g., a serving gateway (S-GW), a packet data network (PDN) gateway (P-GW), and a mobility management entity (MME)). When the communication system 100 is a 5G communication system (e.g., new radio (NR) system), the core network may include an access and mobility management function (AMF), a user plane function (UPF), a session management function (SMF), and the like.

The plurality of communication nodes 110 to 130 may support a communication protocol defined by the 3rd generation partnership project (3GPP) specifications (e.g., LTE communication protocol, LTE-A communication protocol, NR communication protocol, or the like). The plurality of communication nodes 110 to 130 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may have the following structure.

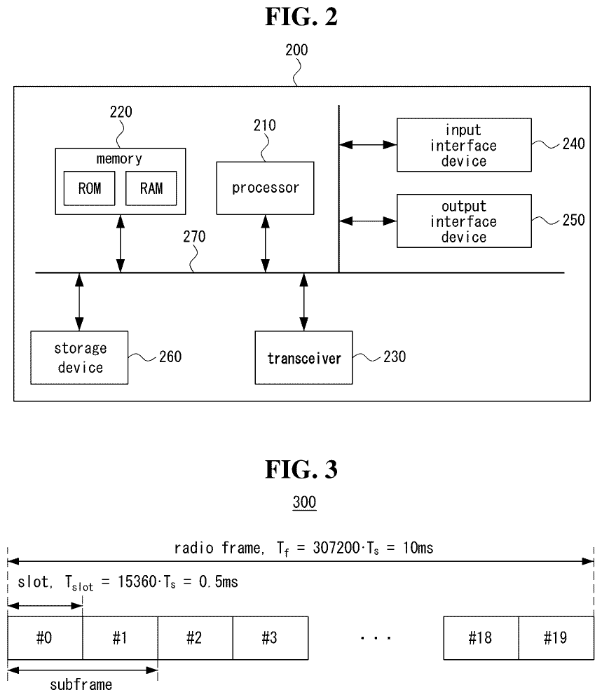

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (COMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, the communication system may support three types of frame structures. A type 1 frame structure may be applied to a frequency division duplex (FDD) communication system, a type 2 frame structure may be applied to a time division duplex (TDD) communication system, and a type 3 frame structure may be applied to an unlicensed band based communication system (e.g., a licensed assisted access (LAA) communication system).

FIG. 3 is a conceptual diagram illustrating a first exemplary embodiment of a type 1 frame.

Referring to FIG. 3, a radio frame 300 may comprise 10 subframes, and a subframe may comprise 2 slots. Thus, the radio frame 300 may comprise 20 slots (e.g., slot #0, slot #1, slot #2, slot #3, . . . , slot #18, and slot #19). The length T_{f} of the radio frame 300 may be 10 milliseconds (ms). The length of the subframe may be 1 ms, and the length Tₛₗₒₜ of a slot may be 0.5 ms. Here, Ts may indicate a sampling time, and may be 1/30,720,000s.

The slot may be composed of a plurality of OFDM symbols in the time domain, and may be composed of a plurality of resource blocks (RBs) in the frequency domain. The RB may be composed of a plurality of subcarriers in the frequency domain. The number of OFDM symbols constituting the slot may vary depending on configuration of a cyclic prefix (CP). The CP may be classified into a normal CP and an extended CP. If the normal CP is used, the slot may be composed of 7 OFDM symbols, in which case the subframe may be composed of 14 OFDM symbols. If the extended CP is used, the slot may be composed of 6 OFDM symbols, in which case the subframe may be composed of 12 OFDM symbols.

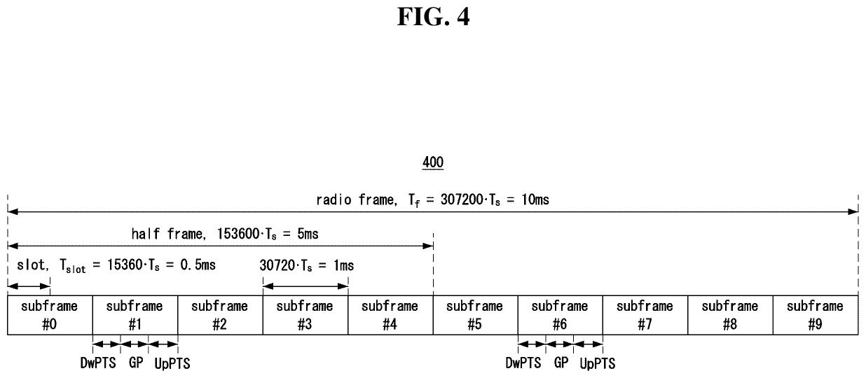

FIG. 4 is a conceptual diagram illustrating a first exemplary embodiment of a type 2 frame.

Referring to FIG. 4, a radio frame 400 may comprise two half frames, and a half frame may comprise 5 subframes. Thus, the radio frame 400 may comprise 10 subframes. The length T_{f} of the radio frame 400 may be 10 ms. The length of the half frame may be 5 ms. The length of the subframe may be 1 ms. Here, Ts may be 1/30,720,000s.

The radio frame 400 may include at least one downlink subframe, at least one uplink subframe, and a least one special subframe. Each of the downlink subframe and the uplink subframe may include two slots. The length Tₛₗₒₜ of a slot may be 0.5 ms. Among the subframes included in the radio frame 400, each of the subframe #1 and the subframe #6 may be a special subframe. For example, when a switching periodicity between downlink and uplink is 5 ms, the radio frame 400 may include 2 special subframes. Alternatively, the switching periodicity between downlink and uplink is 10 ms, the radio frame 400 may include one special subframe. The special subframe may include a downlink pilot time slot (DwPTS), a guard period (GP), and an uplink pilot time slot (UpPTS).

The downlink pilot time slot may be regarded as a downlink interval and may be used for cell search, time and frequency synchronization acquisition of the terminal, channel estimation, and the like. The guard period may be used for resolving interference problems of uplink data transmission caused by delay of downlink data reception. Also, the guard period may include a time required for switching from the downlink data reception operation to the uplink data transmission operation. The uplink pilot time slot may be used for uplink channel estimation, time and frequency synchronization acquisition, and the like. Transmission of a physical random access channel (PRACH) or a sounding reference signal (SRS) may be performed in the uplink pilot time slot.

The lengths of the downlink pilot time slot, the guard period, and the uplink pilot time slot included in the special subframe may be variably adjusted as needed. In addition, the number and position of each of the downlink subframe, the uplink subframe, and the special subframe included in the radio frame 400 may be changed as needed.

In the communication system, a transmission time interval (TTI) may be a basic time unit for transmitting coded data through a physical layer. A short TTI may be used to support low latency requirements in the communication system. The length of the short TTI may be less than 1 ms. The conventional TTI having a length of 1 ms may be referred to as a base TTI or a regular TTI. That is, the base TTI may be composed of one subframe. In order to support transmission on a base TTI basis, signals and channels may be configured on a subframe basis. For example, a cell-specific reference signal (CRS), a physical downlink control channel (PDCCH), a physical downlink shared channel (PDSCH), a physical uplink control channel (PUCCH), a physical uplink shared channel (PUSCH), and the like may exist in each subframe.

On the other hand, a synchronization signal (e.g., a primary synchronization signal (PSS) and a secondary synchronization signal (SSS)) may exist for every 5 subframes, and a physical broadcast channel (PBCH) may exist for every 10 subframes. Also, each radio frame may be identified by an SFN, and the SFN may be used for defining transmission of a signal (e.g., a paging signal, a reference signal for channel estimation, a signal for channel state information, etc.) longer than one radio frame. The periodicity of the SFN may be 1024.

In the LTE system, the PBCH may be a physical layer channel used for transmission of system information (e.g., master information block (MIB)). The PBCH may be transmitted every 10 subframes. That is, the transmission periodicity of the PBCH may be 10 ms, and the PBCH may be transmitted once in the radio frame. The same MIB may be transmitted during 4 consecutive radio frames, and after 4 consecutive radio frames, the MIB may be changed according to a situation of the LTE system. The transmission period for which the same MIB is transmitted may be referred to as a ‘PBCH TTI’, and the PBCH TTI may be 40 ms. That is, the MIB may be changed for each PBCH TTI.

The MIB may be composed of 40 bits. Among the 40 bits constituting the MIB, 3 bits may be used to indicate a system band, 3 bits may be used to indicate physical hybrid automatic repeat request (ARQ) indicator channel (PHICH) related information, 8 bits may be used to indicate an SFN, 10 bits may be configured as reserved bits, and 16 bits may be used for a cyclic redundancy check (CRC).

The SFN for identifying the radio frame may be composed of a total of 10 bits (B9 to B0), and the most significant bits (MSBs) 8 bits (B9 to B2) among the 10 bits may be indicated by the PBCH (i.e., MIB). The MSBs 8 bits (B9 to B2) of the SFN indicated by the PBCH (i.e., MIB) may be identical during 4 consecutive radio frames (i.e., PBCH TTI). The least significant bits (LSBs) 2 bits (B1 to B0) of the SFN may be changed during 4 consecutive radio frames (i.e., PBCH TTI), and may not be explicitly indicated by the PBCH (i.e., MIB). The LSBs (2 bits (B1 to B0)) of the SFN may be implicitly indicated by a scrambling sequence of the PBCH (hereinafter referred to as ‘PBCH scrambling sequence’).

A Gold sequence generated by being initialized by a cell ID may be used as the PBCH scrambling sequence, and the PBCH scrambling sequence may be initialized for each four consecutive radio frames (e.g., each PBCH TTI) based on an operation of ‘mod (SFN, 4)’. The PBCH transmitted in a radio frame corresponding to an SFN with LSBs 2 bits (B1 to B0) set to ‘00’ may be scrambled by the Gold sequence generated by being initialized by the cell ID.

Thereafter, the Gold sequences generated according to the operation of ‘mod (SFN, 4)’ may be used to scramble the PBCH transmitted in the radio frames corresponding to SFNs with LSBs 2 bits (B1 to B0) set to ‘01’, ‘10’, and ‘11’.

Accordingly, the terminal having acquired the cell ID in the initial cell search process may identify the value of the LSBs 2 bits (B1 to B0) of the SFN (e.g., ‘00’, ‘01’, ‘10’, or ‘11’) based on the PBCH scramble sequence obtained in the decoding process for the PBCH (i.e., MIB). The terminal may use the LSBs 2 bits (B1 to B0) of the SFN obtained based on the PBCH scrambling sequence and the MSBs 8 bits (B9 to B2) of the SFN indicated by the PBCH (i.e., MIB) so as to identify the SFN (i.e., the entire bits B9 to B0 of the SFN).

The evolved mobile communication network after the LTE should satisfy technical requirements for supporting more diverse service scenarios as well as a high transmission rate, which has been a major concern in the prior arts. Recently, the ITU-R has defined key performance indicators (KPIs) and requirements for IMT-2020, the official name of 5G mobile communication, which are summarized as a high transmission rate (i.e., enhanced Mobile BroadBand (eMBB)), short transmission latency (i.e., Ultra-Reliable Low-Latency Communication (URLLC)), and massive terminal connectivity (i.e., massive Machine Type Communication (mMTC)). According to the ITU-R projected schedule, it aims to allocate frequencies for IMT-2020 in 2019 and complete international standard approvals by 2020.

The 3GPP is developing a new radio access technology (RAT)-based 5G standard that meets the IMT-2020 requirements. According to the definition of the 3GPP, the new RAT is a radio access technology that does not have backward compatibility with the existing 3GPP RAT. The new radio communication system after the LTE, which adopts such the RAT, will be referred to as new radio (NR) in the present disclosure.

One of characteristics of the NR different from the CDMA and LTE, which are the conventional 3GPP systems, is that it utilizes a wide range of frequency bands to increase transmission capacity. In this regard, the WRC-19 agenda hosted by the ITU was to review 24.25 to 86 GHz frequency bands as candidate frequency bands for IMT-2020. In the 3GPP, bands from a sub-1 GHz band to a 100 GHz band are considered as candidate NR bands.

As a waveform technology for the NR, Orthogonal Frequency Division Multiplexing (OFDM), Filtered OFDM, Generalized Frequency Division Multiplexing (GFDM), Filter Bank Multi-Carrier (FBMC), Universal Filtered Multi-Carrier (UFM|C), and/or the like are discussed as candidate technologies. Although each has pros and cons, Cyclic Prefix (CP)-based OFDM and Single Carrier-Frequency Division Multiple Access (SC-FDMA) are still effective schemes for the 5G system, due to their relatively low implementation complexity at a transceiver and Multiple-Input Multiple-Output (MIMO) scalability. However, in order to flexibly support various 5G usage scenarios, a method of simultaneously accommodating different waveform parameters within one carrier without guard bands may be considered, and for this case, the Filtered OFDM or GFDM having a low out-of-band Emission (OOB) may be suitable.

In the present disclosure, for convenience of description, it is assumed that the CP-based OFDM is used as a waveform technology for radio access. However, this is only for convenience of description, and various exemplary embodiments of the present disclosure are not limited to a specific waveform technology. In general, the category of CP-based OFDM technology includes the Filtered OFDM or Spread Spectrum OFDM (e.g., DFT-spread OFDM) technology.

The subcarrier spacing of the communication system (e.g., OFDM-based communication system) may be determined based on a carrier frequency offset (CFO) and the like. The CFO may be generated by a Doppler effect, a phase drift, or the like, and may increase in proportion to an operation frequency. Therefore, in order to prevent the performance degradation of the communication system due to the CFO, the subcarrier spacing may increase in proportion to the operation frequency. On the other hand, as the subcarrier spacing increases, a CP overhead may increase. Therefore, the subcarrier spacing may be configured based on a channel characteristic, a radio frequency (RF) characteristic, etc. according to a frequency band.

Various numerologies are being considered in the NR system. For example, the subcarrier spacing of the communication system may be configured to 15 kHz, 30 kHz, 60 kHz, or 120 kHz. The subcarrier spacing of the LTE system may be 15 kHz, and the subcarrier spacing of the NR system may be 1, 2, 4, or 8 times the conventional subcarrier spacing of 15 kHz. If the subcarrier spacing increases by exponentiation units of 2 of the conventional subcarrier spacing, the frame structure can be easily designed.

The communication system may support a wide frequency band (e.g., several hundred MHz to tens of GHz). Since the diffraction characteristic and the reflection characteristic of the radio wave are poor in a high frequency band, a propagation loss (e.g., path loss, reflection loss, and the like) in a high frequency band may be larger than a propagation loss in a low frequency band. Therefore, a cell coverage of a communication system supporting a high frequency band may be smaller than a cell coverage of a communication system supporting a low frequency band. In order to solve such the problem, a beamforming scheme based on a plurality of antenna elements may be used to increase the cell coverage in the communication system supporting a high frequency band.

The beamforming scheme may include a digital beamforming scheme, an analog beamforming scheme, a hybrid beamforming scheme, and the like. In the communication system using the digital beamforming scheme, a beamforming gain may be obtained using a plurality of RF paths based on a digital precoder or a codebook. In the communication system using the analog beamforming scheme, a beamforming gain may be obtained using analog RF devices (e.g., phase shifter, power amplifier (PA), variable gain amplifier (VGA), and the like) and an antenna array.

Because of the need for expensive digital to analog converters (DACs) or analog to digital converters (ADCs) for digital beamforming schemes and transceiver units corresponding to the number of antenna elements, the complexity of antenna implementation may be increased to increase the beamforming gain. In case of the communication system using the analog beamforming scheme, since a plurality of antenna elements are connected to one transceiver unit through phase shifters, the complexity of the antenna implementation may not increase greatly even if the beamforming gain is increased. However, the beamforming performance of the communication system using the analog beamforming scheme may be lower than the beamforming performance of the communication system using the digital beamforming scheme. Further, in the communication system using the analog beamforming scheme, since the phase shifter is adjusted in the time domain, frequency resources may not be efficiently used. Therefore, a hybrid beam forming scheme, which is a combination of the digital scheme and the analog scheme, may be used.

When the cell coverage is increased by the use of the beamforming scheme, common control channels and common signals (e.g., reference signal and synchronization signal) for all terminals belonging to the cell coverage as well as control channels and data channels for each terminal may also be transmitted based on the beamforming scheme. In the case of transmitting a common control channel or signal to all terminals while increasing the cell coverage by applying beamforming, it may be difficult to transmit the common control channel or signal to the entire cell coverage by single transmission, and the common control channel or signal should be transmitted several times over multiple beams. A scheme of transmitting a channel or signal several times through different beams over a period of time may be referred to as beam sweeping. When a common control channel or signal is transmitted by applying beamforming, such the beam sweeping operation is absolutely necessary.

A terminal desiring to access the system may acquire downlink frequency/time synchronization and cell ID information using a synchronization signal, acquire uplink synchronization through a random access procedure, and form a radio link. In this case, in the NR system, a synchronization signal/physical broadcast channel (SS/PBCH) block may also be transmitted in a beam sweeping scheme. The SS/PBCH block may be composed of a PSS, an SSS, a PBCH, and the like. In the SS/PBCH block, the PSS, the SSS, and the PBCH may be configured in a time division multiplexing (TDM) manner. The SS/PBCH block may be referred also to as an ‘SS block (SSB)’. One SS/PBCH block may be transmitted using N consecutive OFDM symbols. Here, N may be an integer equal to or greater than 4. The base station may periodically transmit the SS/PBCH block, and the terminal may acquire frequency/time synchronization, a cell ID, system information, and the like based on the SS/PBCH block received from the base station. The SS/PBCH block may be transmitted as follows.

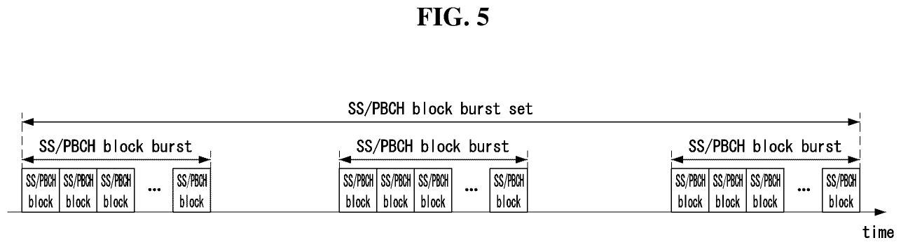

FIG. 5 is a conceptual diagram illustrating a first exemplary embodiment of a transmission method of SS/PBCH block in a communication system.

Referring to FIG. 5, one or more SS/PBCH blocks may be transmitted in a beam sweeping scheme within an SS/PBCH block burst set. Up to L SS/PBCH blocks may be transmitted within one SS/PBCH block burst set. L may be an integer equal to or greater than 2, and may be defined in the 3GPP standard. Depending on a region of a system frequency, L may vary. Within the SS/PBCH block burst set, the SS/PBCH blocks may be located consecutively or distributedly. The consecutive SS/PBCH blocks may be referred to as an ‘SS/PBCH block burst’. The SS/PBCH block burst set may be repeated periodically, and system information (e.g., MIB) transmitted through the PBCHs of the SS/PBCH blocks within the SS/PBCH block burst set may be the same. An index of the SS/PBCH block, an index of the SS/PBCH block burst, an index of an OFDM symbol, an index of a slot, and the like may be indicated explicitly or implicitly by the PBCH.

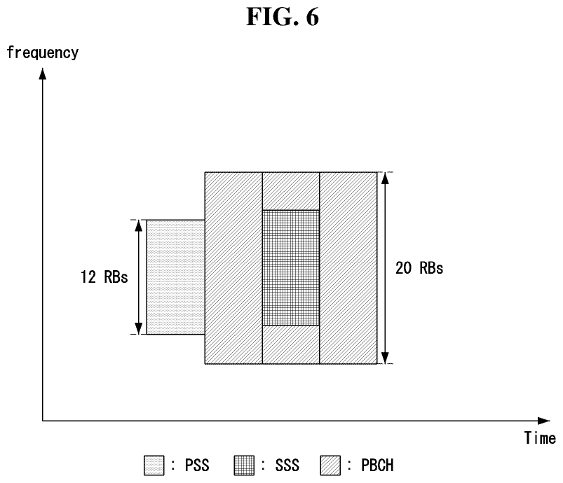

FIG. 6 is a conceptual diagram illustrating a first exemplary embodiment of an SS/PBCH block in a communication system.

Referring to FIG. 6, signals and a channel are arranged within one SS/PBCH block in the order of ‘PSS→PBCH→SSS→PBCH’. The PSS, SSS, and PBCH within the SS/PBCH block may be configured in a TDM scheme. In a symbol where the SSS is located, the PBCH may be located in frequency resources above the SSS and frequency resources below the SSS. That is, the PBCH may be transmitted in both end bands adjacent to the frequency band in which the SSS is transmitted. When the maximum number of SS/PBCH blocks is 8 in the sub 6 GHz frequency band, an SS/PBCH block index may be identified based on a demodulation reference signal used for demodulating the PBCH (hereinafter, referred to as ‘PBCH DMRS’). When the maximum number of SSBs is 64 in the over 6 GHz frequency band, LSB 3 bits of 6 bits representing the SS/PBCH block index may be identified based on the PBCH DMRS, and the remaining MSB 3 bits may be identified based on a payload of the PBCH.

The maximum system bandwidth that can be supported in the NR system may be 400 MHz. The size of the maximum bandwidth that can be supported by the terminal may vary depending on the capability of the terminal. Therefore, the terminal may perform an initial access procedure (e.g., initial connection procedure) by using some of the system bandwidth of the NR system supporting a wide band. In order to support access procedures of terminals supporting various sizes of bandwidths, SS/PBCH blocks may be multiplexed in the frequency domain within the system bandwidth of the NR system supporting a wide band. In this case, the SS/PBCH blocks may be transmitted as follows.

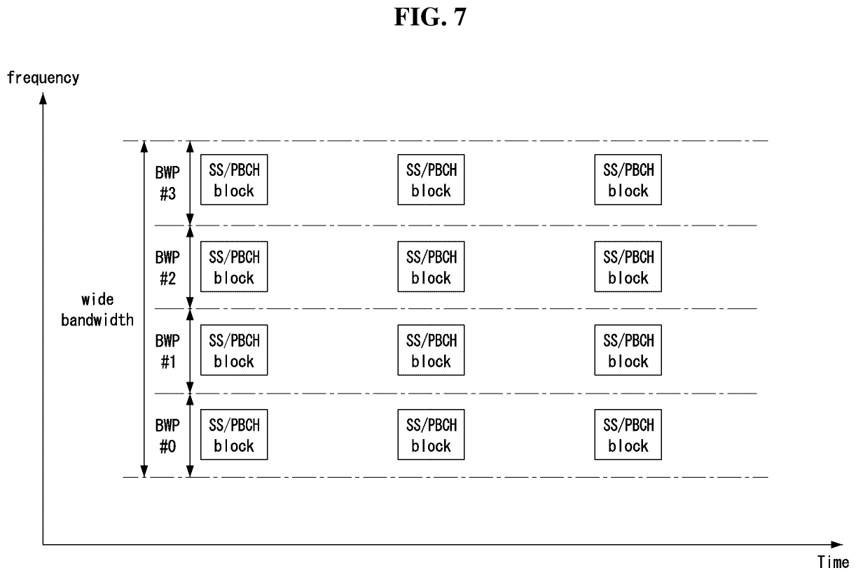

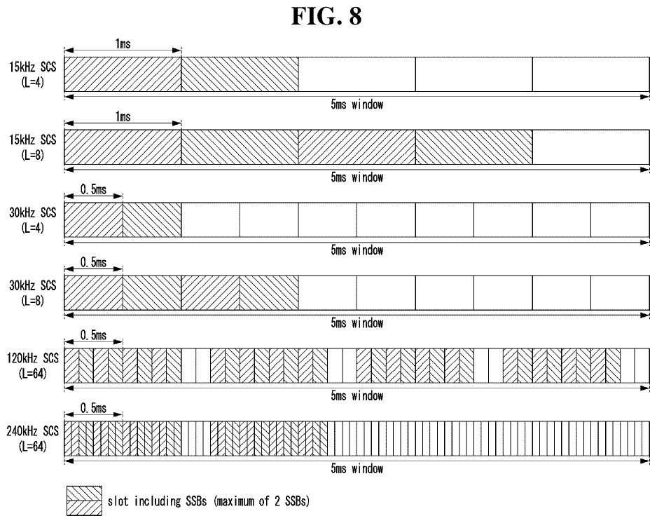

FIG. 7 is a conceptual diagram illustrating a second exemplary embodiment of a method of transmitting SS/PBCH blocks in a communication system.

Referring to FIG. 7, a wideband component carrier (CC) may include a plurality of bandwidth parts (BWPs). For example, the wideband CC may include 4 BWPs. The base station may transmit SS/PBCH blocks in the respective BWPs #0 to #3 belonging to the wideband CC. The terminal may receive the SS/PBCH block(s) from one or more BWPs of the BWPs #0 to #3, and may perform an initial access procedure using the received SS/PBCH block.

After detecting the SS/PBCH block, the terminal may acquire system information (e.g., remaining minimum system information (RMSI)), and may perform a cell access procedure based on the system information. The RMSI may be transmitted on a PDSCH scheduled by a PDCCH. Configuration information of a control resource set (CORESET) in which the PDCCH including scheduling information of the PDSCH through which the RMSI is transmitted may be transmitted on a PBCH within the SS/PBCH block. A plurality of SS/PBCH blocks may be transmitted in the entire system band, and one or more SS/PBCH blocks among the plurality of SS/PBCH blocks may be SS/PBCH block(s) associated with the RMSI. The remaining SS/PBCH blocks may not be associated with the RMSI. The SS/PBCH block associated with the RMSI may be defined as a ‘cell defining SS/PBCH block’. The terminal may perform a cell search procedure and an initial access procedure by using the cell-defining SS/PBCH block. The SS/PBCH block not associated with the RMSI may be used for a synchronization procedure and/or a measurement procedure in the corresponding BWP. The BWP(s) through which the SS/PBCH block is transmitted may be limited to one or more BWPs within a wide bandwidth.

The RMSI may be obtained by performing an operation to obtain configuration information of a CORESET from the SS/PBCH block (e.g., PBCH), an operation of detecting a PDCCH based on the configuration information of the CORESET, an operation to obtain scheduling information of a PDSCH from the PDCCH, and an operation to receive the RMSI through the PDSCH. A transmission resource of the PDCCH may be configured by the configuration information of the CORESET. A mapping patter of the RMSI CORESET pattern may be defined as follows. The RMSI CORESET may be a CORESET used for transmission and reception of the RMSI.

FIG. 8 is a conceptual diagram for describing time domain transmission positions of SSBs according to a subcarrier spacing and L.

The time domain positions where SSB(s) are transmitted may be differently defined according to a subcarrier spacing and a value of L. Short UL transmission such as uplink control information (UCI) may be performed in symbol(s) where SSB(s) are not transmitted within one slot. In transmission of SSB(s) having a large subcarrier spacing (e.g., 120 kHz or 240 kHz SCS), a gap may be configured in the middle of consecutive slots containing the SSB(s) so that long UL transmission such as URLLC traffic can be performed at least every 1 ms.

As in the example of FIG. 8, a gap for UL transmission may be configured after 8 slots containing SSBs having 120 kHz subcarrier spacing, and a gap for UL transmission may be configured after 16 slots containing SSBs having 240 kHz subcarrier spacing.

As described above, candidate positions may be determined so that up to L SSBs can be transmitted within an SSB burst set, and L may vary depending on a frequency region. For example, in an FR1 band, up to 4 SSBs can be transmitted in a frequency band between 0 and 3 GHz, up to 8 SSBs can be transmitted in a frequency band above. In an FR 2 band, up to 64 SSBs can be transmitted. In this case, depending on a system environment, SSBs may be actually transmitted in all of the L positions, or may be transmitted only in some of the L positions. At this time, when a terminal receiving data receives the data at the candidate position(s) of the SSBs, the terminal may determine whether to perform rate-matching on the received data depending on whether or not SSB(s) are actually transmitted at the corresponding position(s). In this case, information on the position(s) where SSB(s) are actually transmitted may be delivered to the terminal through RMSI and/or user equipment (UE)-specific RRC signaling. When delivered through RMSI, in case of L=4 or 8, the position(s) where SSB(s) are actually transmitted may be marked as ‘1’ and position(s) where SSB(s) are not transmitted may be marked as ‘0’ through bitmap information. In case of L=64, information on 64 positions is transmitted in a compressed form of 16 bits. More specifically, L=64 SSBs may be divided into 8 groups each comprising 8 SSBs, and 8 SSBs within a group may represented by an 8-bit bitmap. The 8 groups may be represented by an 8-bit bitmap, so that the entire bitmap may be configured with 16 bits. Therefore, all groups have the same intra-group SSB transmission pattern.

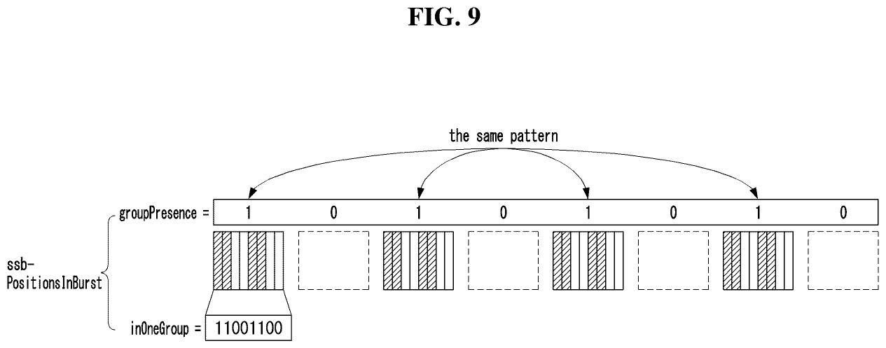

FIG. 9 is a conceptual diagram illustrating an example for indicating position(s) where SSB(s) are actually transmitted in an FR2 band through RMSI.

A parameter ssb-PositionsInBurst, which indicates transmission positions, may be composed of two parameters, inOneGroup and groupPresence, and each parameter is configured with 8 bits. Among these, inOneGroup may indicate whether each SSB is transmitted within a group using an 8-bit bitmap, and groupPresence may indicate whether each group is transmitted. In this case, group(s) signaled (i.e. marked as ‘1’ in the 8-bit bitmap) as ‘transmitted group(s)’ through groupPresence may all have SSB transmission positions of the same pattern signaled as inOneGroup. Through the above-described signaling scheme, the actual transmission positions for 64 SSB candidate positions can be signaled with 16 bits, thereby reducing signaling overhead. However, the signaled transmission positions may be different from transmission positions where SSB(s) are actually transmitted. For example, even if the patterns of the first and third groups in FIG. 9 are desired to be actually operated differently, this cannot be signaled. Therefore, to solve this problem, the actual transmission position(s) of SSB(s) may be additionally signaled as a 64-bit bitmap through UE-specific RRC signaling. When delivered through UE-specific RRC signaling, it may be delivered as a full bitmap regardless of the value of L.

As described above, RMSI reception may be performed through a series of processes of detecting a PDCCH based on CORESET configuration information transmitted through a PBCH, obtaining scheduling information of RMSI based on the PDCCH, and then receiving a PDSCH according to the scheduling information. In this case, a control channel resource region where PDCCHs can be transmitted may be configured based on the RMSI CORESET configuration information, which may have three main patterns as follows.

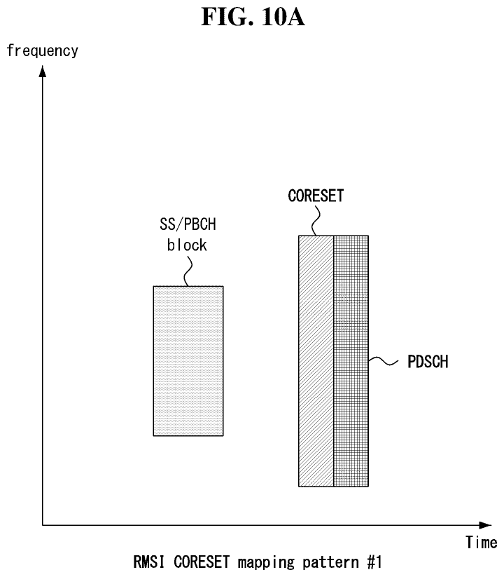

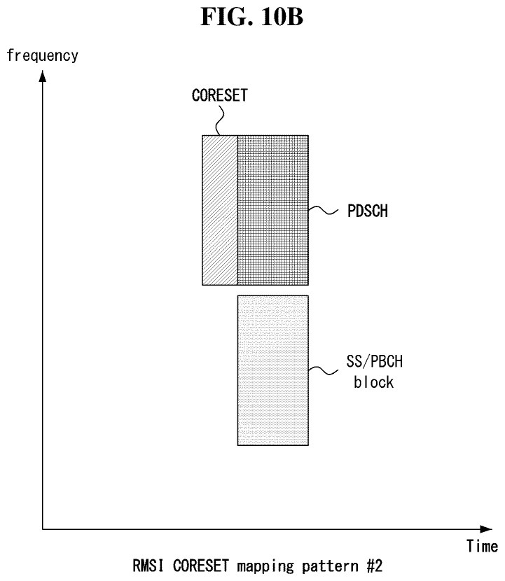

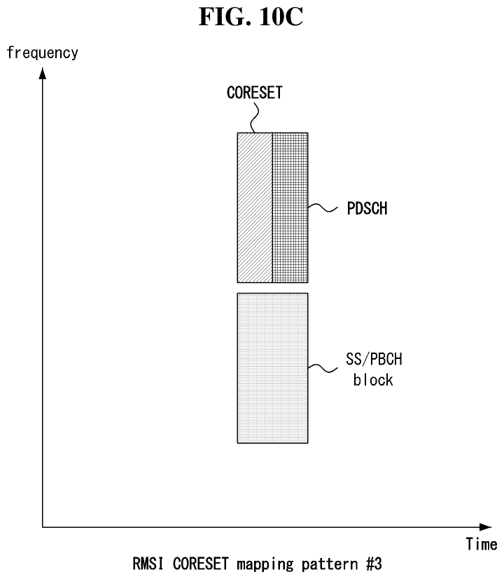

FIG. 10A is a conceptual diagram illustrating an RMSI CORESET mapping pattern #1 in a communication system, FIG. 10B is a conceptual diagram illustrating an RMSI CORESET mapping pattern #2 in a communication system, and FIG. 10C is a conceptual diagram illustrating an RMSI CORESET mapping pattern #3 in a communication system.

Referring to FIGS. 10A to 10C, one RMSI CORESET mapping pattern among the RMSI CORESET mapping patterns #1 to #3 may be used, and a detailed configuration according to the one RMSI CORESET mapping pattern may be determined. In the RMSI CORESET mapping pattern #1, the SS/PBCH block, the CORESET (i.e., RMSI CORESET), and the PDSCH (i.e., RMSI PDSCH) may be configured in a TDM scheme. The RMSI PDSCH may mean the PDSCH through which the RMSI is transmitted. In the RMSI CORESET mapping pattern #2, the CORESET (i.e., RMSI CORESET) and the PDSCH (i.e., RMSI PDSCH) may be configured in a TDM scheme, and the PDSCH (i.e., RMSI PDSCH) and the SS/PBCH block may be configured in a frequency division multiplexing (FDM) scheme. In the RMSI CORESET mapping pattern #3, the CORESET (i.e., RMSI CORESET) and the PDSCH (i.e., RMSI PDSCH) may be configured in a TDM scheme, and the CORESET (i.e., RMSI CORESET) and the PDSCH (i.e., RMSI PDSCH) may be multiplexed with the SS/PBCH block in a FDM scheme.

In the frequency band of 6 GHz or below, only the RMSI CORESET mapping pattern #1 may be used. In the frequency band of 6 GHz or above, all of the RMSI CORESET mapping patterns #1, #2, and #3 may be used. The numerology of the SS/PBCH block may be different from that of the RMSI CORESET and the RMSI PDSCH. Here, the numerology may be a subcarrier spacing. In the RMSI CORESET mapping pattern #1, a combination of all numerologies may be used. In the RMSI CORESET mapping pattern #2, a combination of numerologies (120 kHz, 60 kHz) or (240 kHz, 120 kHz) may be used for the SS/PBCH block and the RMSI CORESET/PDSCH. In the RMSI CORESET mapping pattern #3, a combination of numerologies (120 kHz, 120 kHz) may be used for the SS/PBCH block and the RMSI CORESET/PDSCH.

One RMSI CORESET mapping pattern may be selected from the RMSI CORESET mapping patterns #1 to #3 according to the combination of the numerology of the SS/PBCH block and the numerology of the RMSI CORESET/PDSCH. The configuration information of the RMSI CORESET may include Table A and Table B. Table A may represent the number of resource blocks (RBs) of the RMSI CORESET, the number of symbols of the RMSI CORESET, and an offset between an RB (e.g., starting RB or ending RB) of the SS/PBCH block and an RB (e.g., starting RB or ending RB) of the RMSI CORESET. Table B may represent the number of search space sets per slot, an offset of the RMSI CORESET, and an OFDM symbol index in each of the RMSI CORESET mapping patterns. Table B may represent information for configuring a monitoring occasion of the RMSI PDCCH. Each of Table A and Table B may be composed of a plurality of sub-tables. For example, Table A may include sub-tables 13-1 to 13-8 defined in the technical specification (TS) 38.213, and Table B may include sub-tables 13-9 to 13-13 defined in the TS 38.213. The size of each of Table A and Table B may be 4 bits.

In the case of the pattern #1 among three patterns for RMSI CORESET configurations shown in FIGS. 10A to 10C, the terminal may monitor a Type 0 CSS in two consecutive slots, and a position no of a start slot for the Type 0 CSS monitoring may be calculated by Equation 1 below.

$${n}_{0} = ( 0 \cdot {2}^{μ} + ⌊ i \cdot M ⌋ ) mod {N}_{slot}^{frame , μ} \qquad [ Equation 1 ]$$

In Equation 1, u is a parameter indicating a subcarrier spacing. A subcarrier spacing of 15 kHz is indicated by μ=0, a subcarrier spacing of 30 kHz is indicated by μ=1, a subcarrier spacing of 60 kHz is indicated by u=2, and a subcarrier spacing of 120 kHz is indicated by μ=3. i indicates an SSB index of an SSB that the terminal receives from the base station (or, SSB that the base station transmits to the terminal), and in the case of operations in an unlicensed band, an SSB candidate index ī of the SSB that the terminal receives from the base station (or, SSB that the base station transmits to the terminal) may be used instead of the SSB index i. Nₛₗₒₜ^{frame,μ} represents the number of slots having a subcarrier spacing corresponding to u within a radio frame, and O and M are parameters configurable for scheduling flexibility of the base station. Specifically, when calculating a position of Type 0 CSS slots, O may indicate an offset between the SSB and the Type 0 CSS slot, and M may determine whether Type 0 CSS monitoring slots overlap or not when performing monitoring in two consecutive slots. M may be set to one of ½, 1, and 2, and a degree of overlapping between Type 0 CSS monitoring slots corresponding to SSB indexes may be configured differently according to M.

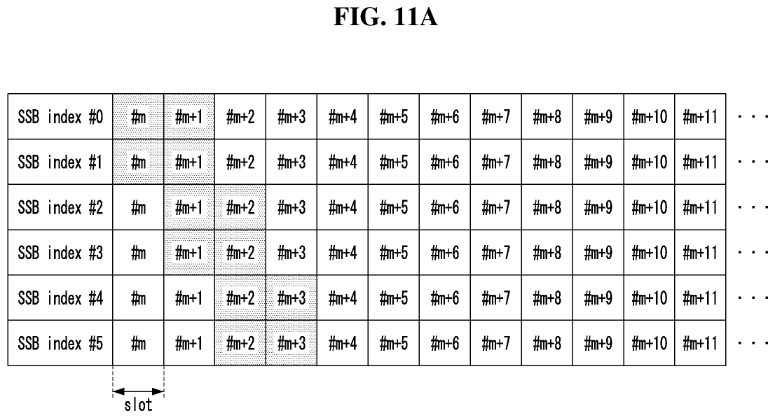

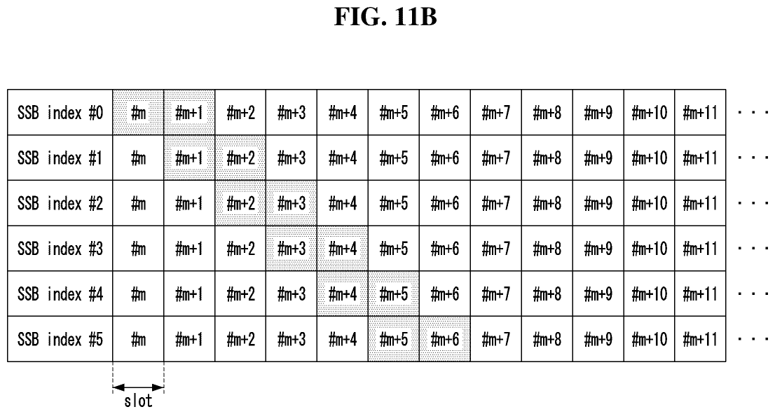

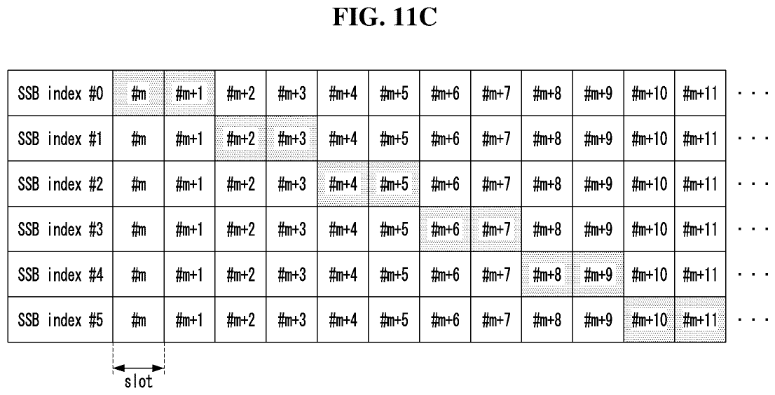

FIGS. 11A to 11C are diagrams for describing examples of various configurations of Type 0 CSS slots corresponding to SSB indexes.

Referring to FIG. 11A, in the case of M=1/2, Type 0 CSS slots (e.g., slot #m and slot #m+1) corresponding to two SSB indexes (e.g., SSB index #0 and SSB index #1) may be configured to be completely overlapped. Type 0 CSS slots (e.g., slot #m+1 and slot #m+2) corresponding to the next two SSB indexes (e.g., SSB index #2 and SSB index #3) may overlap only in one slot with the previous slots.

Referring to FIG. 11B, in the case of M=1, the first slot among two consecutive slots corresponding to each SSB index may be configured to overlap the second slot among two slots corresponding to a previous SSB index.

Referring to FIG. 11C, in the case of M=2, two consecutive slots corresponding to each SSB index may be configured not to overlap slots corresponding to other SSB indexes.

In the NR system, a PDSCH may be mapped to the time domain according to a PDSCH mapping type A or a PDSCH mapping type B. The PDSCH mapping types A and B may be defined as Table 2 below.

TABLE 1

| PDSCH | | | | | | |
|---|---|---|---|---|---|---|
| mapping | Normal CP | | | Extended CP | | |
| type | S | L | S + L | S | L | S + L |
| Type A | {0, 1, 2, 3} | {3, . . . , | {3, . . . , | {0, 1, 2, 3} | {3, . . . , | {3, . . . , |
| | (Note 1) | 14} | 14} | (Note 1) | 12} | 12} |
| Type B | {0, . . . , | {2, 4, 7} | {2, . . . , | {0, . . . , | {2 ,4, 6} | {2, . . . , |
| | 12} | | 14} | 10} | | 12} |

Note 1:
S = 3 is applicable only if dmrs-TypeA-Position = 3

The type A (i.e., PDSCH mapping type A) may be slot-based transmission. When the type A is used, a position of a start symbol of a PDSCH may be configured to one of {0, 1, 2, 3}. When the type A and a normal CP are used, the number of symbols constituting the PDSCH (e.g., the duration of the PDSCH) may be configured to one of 3 to 14 within a range not exceeding a slot boundary. The type B (i.e., PDSCH mapping type B) may be non-slot-based transmission. When the type B is used, a position of a start symbol of a PDSCH may be configured to one of 0 to 12. When the type B and the normal CP are used, the number of symbols constituting the PDSCH (e.g., the duration of the PDSCH) may be configured to one of {2, 4, 7} within a range not exceeding a slot boundary. A DMRS (hereinafter, referred to as ‘PDSCH DMRS’) for demodulation of the PDSCH (e.g., data) may be determined by a value of ID indicating the PDSCH mapping type (e.g., type A or type B) and the length. The ID may be defined differently according to the PDSCH mapping type.

As NR phase 1 standardization is completed in releas-15 and NR phase 2 standardization begins in release-16, new features of the NR system are being discussed. One of the representative features is NR-Unlicensed (U). The NR-U is a technology to support operations in an unlicensed spectrum used for purposes such as Wi-Fi to increase network capacity by increasing utilization of limited frequency resources. For such the operations in an unlicensed spectrum, standardization started with the LTE-Licensed-Assisted Access (LAA) technology from Release-13, and has continued to evolve through release-14 LTE-Enhanced LAA (eLAA) and releas-15 LTE-Further Enhanced LAA (FeLAA). In the NR, standardization work is in progress as a work item (WI) in release-16 after a study item (SI) for the NR-U.

In the NR-U system, the terminal may determine whether a signal is transmitted from a base station based on a discovery reference signal (DRS) received from the corresponding base station in the same manner as in the general NR system. In the NR-U system in a Stand-Alone (SA) mode, the terminal may acquire synchronization and/or system information based on the DRS. In the NR-U system, the DRS may be transmitted according to a regulation of the unlicensed band (e.g., transmission band, transmission power, transmission time, etc.). For example, according to Occupied Channel Bandwidth (OCB) regulations, signals may be configured and/or transmitted to occupy 80% of the total channel bandwidth (e.g., 20 MHz).

In the NR-U system, a communication node (e.g., base station, terminal) may perform a Listen Before Talk (LBT) procedure before transmitting a signal and/or a channel for coexistence with another system. The signal may be a synchronization signal, a reference signal (e.g., DRS, DMRS, channel state information (CSI)-RS, phase tracking (PT)-RS, sounding reference signal (SRS)), or the like. The channel may be a downlink channel, an uplink channel, a sidelink channel, or the like. In exemplary embodiments, a signal may mean the ‘signal’, the ‘channel’, or the ‘signal and channel’. The LBT procedure may be an operation for checking whether a signal is transmitted by another communication node. If it is determined by the LBT procedure that there is no transmission signal (e.g., when the LBT procedure is successful), the communication node may transmit a signal in the unlicensed band. If it is determined by the LBT procedure that a transmission signal exists (e.g., when the LBT fails), the communication node may not be able to transmit a signal in the unlicensed band. The communication node may perform a LBT procedure according to one of various categories before transmission of a signal. The category of LBT may vary depending on the type of the transmission signal.

Meanwhile, NR vehicle-to-everything (V2X) communication technology is being discussed in the NR standardization meeting. The NR V2X communication technology may be a technology that supports communication between vehicles, communication between a vehicle and an infrastructure, communication between a vehicle and a pedestrian, and the like based on device-to-device (D2D) communication technologies. Techniques for reducing power consumption and improving reliability are being discussed for NR V2C communication.

The NR V2X communication (e.g., sidelink communication) may be performed according to three transmission schemes (e.g., unicast scheme, broadcast scheme, groupcast scheme). When the unicast scheme is used, a PC5-RRC connection may be established between a first terminal (e.g. transmitting terminal that transmits data) and a second terminal (e.g., receiving terminal that receives data), and the PC5-RRC connection may refer to a logical connection for a pair between a source ID of the first terminal and a destination ID of the second terminal. The first terminal may transmit data (e.g., sidelink data) to the second terminal. When the broadcast scheme is used, the first terminal may transmit data to all terminals. When the groupcast scheme is used, the first terminal may transmit data to a group (e.g., groupcast group) composed of a plurality of terminals. In SL communication (e.g., SL-U communication), a transmitting terminal may mean a terminal transmitting data, and a receiving terminal may mean a terminal receiving the data.

When the unicast scheme is used, the second terminal may transmit feedback information (e.g., acknowledgment (ACK) or negative ACK (NACK)) to the first terminal in response to data received from the first terminal. In the exemplary embodiments below, the feedback information may be referred to as a ‘HARQ-ACK’, ‘feedback signal’, a ‘physical sidelink feedback channel (PSFCH) signal’, or the like. When ACK is received from the second terminal, the first terminal may determine that the data has been successfully received at the second terminal. When NACK is received from the second terminal, the first terminal may determine that the second terminal has failed to receive the data. In this case, the first terminal may transmit additional information to the second terminal based on an HARQ scheme. Alternatively, the first terminal may improve a reception probability of the data at the second terminal by retransmitting the same data to the second terminal.

When the broadcast scheme is used, a procedure for transmitting feedback information for data may not be performed. For example, system information may be transmitted in the broadcast scheme, and the terminal may not transmit feedback information for the system information to the base station. Therefore, the base station may not identify whether the system information has been successfully received at the terminal. To solve this problem, the base station may periodically broadcast the system information.

When the groupcast scheme is used, a procedure for transmitting feedback information for data may not be performed. For example, necessary information may be periodically transmitted in the groupcast scheme, without the procedure for transmitting feedback information. However, when the candidates of terminals participating in the groupcast scheme-based communication and/or the number of the terminals participating in that is limited, and the data transmitted in the groupcast scheme is data that should be received within a preconfigured time (e.g., data sensitive to delay), it may be necessary to transmit feedback information also in the groupcast sidelink communication. The groupcast sidelink communication may mean sidelink communication performed in the groupcast scheme. When the feedback information transmission procedure is performed in the groupcast sidelink communication, data can be transmitted and received efficiently and reliably.

In the groupcast sidelink communication, two HARQ-ACK feedback schemes (i.e., transmission procedures of feedback information) may be supported. When the number of receiving terminals in a sidelink group is large and a service scenario 1 is supported, some receiving terminals belonging to a specific range within the sidelink group may transmit NACK through a PSFCH when data reception fails. This scheme may be a groupcast HARQ-ACK feedback option 1. In the service scenario 1, instead of all the receiving terminals in the sidelink group, it may be allowed for some receiving terminals belonging to a specific range to perform reception in a best-effort manner. The service scenario 1 may be an extended sensor scenario in which some receiving terminals belonging to a specific range need to receive the same sensor information from a transmitting terminal. In exemplary embodiments, the transmitting terminal may refer to a terminal transmitting data, and the receiving terminal may refer to a terminal receiving data.

When the number of receiving terminals in the sidelink group is limited and a service scenario 2 is supported, each of all the receiving terminals belonging to the sidelink group may report HARQ-ACK for data individually through a separate PSFCH. This scheme may be a groupcast HARQ-ACK feedback option 2. In the service scenario 2, since PSFCH resources are sufficient, the transmitting terminal may perform monitoring on HARQ-ACK feedbacks of all the receiving terminals belonging to the sidelink group, and data reception may be guaranteed at all the receiving terminals belonging to the sidelink group.

As in broadcast sidelink communication, data may be transmitted and received without a HARQ-ACK feedback procedure in unicast sidelink communication and groupcast sidelink communication. In this case, in order to increase a probability of receiving the data, a transmitting terminal may retransmit the data a preset number of times.

In all transmission schemes (e.g., unicast transmission, groupcast transmission, and broadcast transmission), whether a HARQ-ACK feedback procedure is applied may be statically or semi-statically configured to the terminal(s) by signaling (e.g., system information signaling, PC5-RRC signaling, UE-specific RRC signaling, control information signaling). In sidelink communication, HARQ-ACK feedback information may be transmitted on a PSFCH. If reception of a PSSCH is successful, a receiving terminal may transmit ACK for the PSSCH (e.g., data) on the PSFCH. If reception of the PSSCH fails, the receiving terminal may transmit NACK for the PSSCH (e.g., data) on the PSFCH. The PSFCH may be a channel for reporting ACK/NACK information (e.g., HARQ-ACK feedback) to the transmitting terminal. A resource region (e.g., PSFCH resource region) for PSFCH transmission (e.g., transmission of HARQ-ACK feedback) may be preconfigured within a specific resource pool. The PSFCH (e.g., PSFCH resource or PSFH resource region) may be configured periodically. A PSFCH periodicity for the PSFCH resource may be k slots (e.g., logical sidelink (SL) slots). k may be a natural number. For example, k may be 1, 2, or 4.

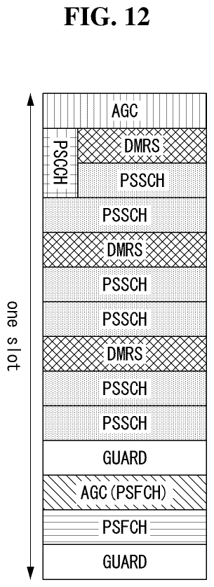

FIG. 12 is a conceptual diagram illustrating a first exemplary embodiment of configuration of a slot in which a PSFCH is configured.

Referring to FIG. 12, a PSFCH (e.g., HARQ-ACK feedback) may be repeatedly transmitted in two symbols (e.g., two OFDM symbols) within a slot (e.g., SL slot). The first symbol among two symbols in which the PSFCH is transmitted may be used for automatic gain control (AGC) for correct PSFCH receive power level adjustment.

The PSFCH may be transmitted within a frequency resource region preconfigured by system information. In this case, the frequency resource region for PSFCH transmission may be indicated (e.g., signaled) in form of a bitmap within the resource pool. The receiving terminal may implicitly select a location of the frequency resource region for PSFCH transmission based on indexes of a slot and a subchannel in which a PSSCH is received. The receiving terminal may identify the number of resource blocks (RBs) and the number of PSFCH resources multiplexable based on cyclic shifts of a PSFCH sequence within the frequency resource region. The receiving terminal may implicitly select a PSFCH index for PSFCH resource(s) based on a source identifier (ID) and a member ID. The source ID may be a physical layer source ID. The source ID may be an ID of a transmitting terminal that has transmitted the PSSCH.

The member ID may be used in the groupcast HARQ-ACK feedback option 2. When the groupcast HARQ-ACK feedback option 2 is applied, each of all receiving terminals within a group may individually transmit a HARQ-ACK feedback for SL data through a separate PSFCH (e.g., PSFCH resource). In a case other than the above-described exemplary embodiment, the member ID may be set to 0.

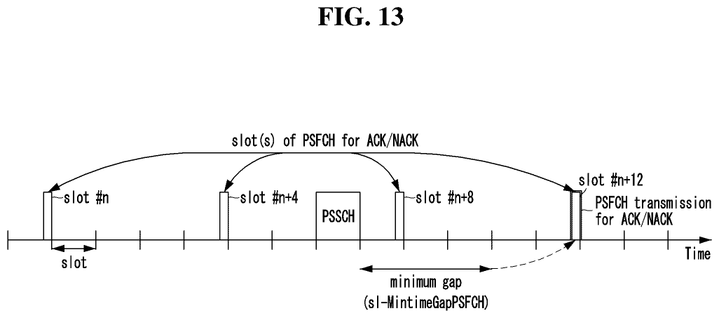

FIG. 13 is a conceptual diagram illustrating a first exemplary embodiment of a PSFCH for ACK/NACK transmission.

Referring to FIG. 13, a transmission time of a PSFCH may be the first slot (e.g., PSFCH slot) in which PSFCH transmission is possible after a preset time (e.g., sl-MinTimeGapPSFCH) from a reception time of a corresponding PSSCH. The PSFCH slot may be a slot capable of transmitting a PSFCH and/or a slot in which a PSFCH is configured. sl-MinTime GapPSFCH may be set in consideration of a time required for processing the PSSCH after reception of the PSSCH and a time required for preparing for ACK/NACK (e.g., HARQ-ACK feedback) depending on whether reception of the PSSCH is successful. sl-MinTimeGapPSFCH may be set to 2 or 3 slots. The terminal (e.g., receiving terminal) may transmit the PSFCH in a slot #n+12, which is a slot capable of PSFCH transmission, after sl-MinTimeGapPSFCH (e.g., 3 slots) from a reception time of the PSSCH. n may be an integer greater than or equal to 0. In the present disclosure, the reception time may mean a reception start time and/or a reception end time, and the transmission time may mean a transmission start time and/or a transmission end time. The time may mean a timing and/or duration.

Data reliability at the receiving terminal may be improved by appropriately adjusting a transmit power of the transmitting terminal according to a transmission environment. Interference to other terminals may be mitigated by appropriately adjusting the transmit power of the transmitting terminal. Energy efficiency can be improved by reducing unnecessary transmit power. A power control scheme may be classified into an open-loop power control scheme and a closed-loop power control scheme. In the open-loop power control scheme, the transmitting terminal may determine the transmit power in consideration of configuration, a measured environment, etc. In the closed-loop power control scheme, the transmitting terminal may determine the transmit power based on a transmit power control (TPC) command received from the receiving terminal.

It may be difficult due to various causes including a multipath fading channel, interference, and the like to predict a received signal strength at the receiving terminal. Accordingly, the receiving terminal may adjust a receive power level (e.g., receive power range) by performing an automatic gain control (AGC) operation to prevent a quantization error of the received signal and maintain a proper receive power. In the communication system, the terminal may perform the AGC operation using a reference signal received from the base station. However, in the sidelink communication (e.g., V2X communication), the reference signal may not be transmitted from the base station. That is, in the sidelink communication, communication between terminals may be performed without the base station. Therefore, it may be difficult to perform the AGC operation in the sidelink communication. In the sidelink communication, the transmitting terminal may first transmit a signal (e.g., reference signal) to the receiving terminal before transmitting data, and the receiving terminal may adjust a receive power range (e.g., receive power level) by performing an AGC operation based on the signal received from the transmitting terminal. Thereafter, the transmitting terminal may transmit sidelink data to the receiving terminal. The signal used for the AGC operation may be a signal duplicated from a signal to be transmitted later or a signal preconfigured between the terminals.

A time period required for the ACG operation may be 15 μs. When a subcarrier spacing of 15 kHz is used in the NR system, a time period (e.g., length) of one symbol (e.g., OFDM symbol) may be 66.7 μs. When a subcarrier spacing of 30 kHz is used in the NR system, a time period of one symbol (e.g., OFDM symbol) may be 33.3 μs. In the following exemplary embodiments, a symbol may mean an OFDM symbol. That is, a time period of one symbol may be twice or more than a time period required for the ACG operation.

For sidelink communication, it may be necessary to transmit a data channel for data transmission and a control channel including scheduling information for data resource allocation. In sidelink communication, the data channel may be a physical sidelink shared channel (PSSCH), and the control channel may be a physical sidelink control channel (PSCCH). The data channel and the control channel may be multiplexed in a resource domain (e.g., time and frequency resource domains).

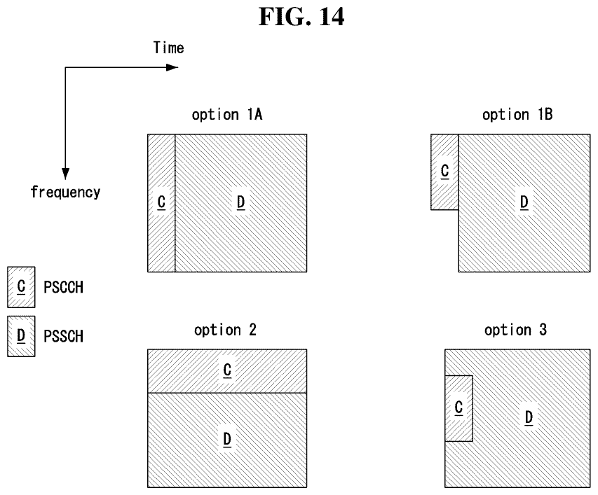

FIG. 14 is a conceptual diagram illustrating exemplary embodiments of a method for multiplexing a control channel and a data channel in sidelink communication.

Referring to FIG. 14, sidelink communication may support an option 1A, an option 1B, an option 2, and an option 3. When the option 1A and/or the option 1B is supported, a control channel and a data channel may be multiplexed in the time domain. When the option 2 is supported, a control channel and a data channel may be multiplexed in the frequency domain. When the option 3 is supported, a control channel and a data channel may be multiplexed in the time and frequency domains. The sidelink communication may basically support the option 3.

In the sidelink communication (e.g., NR-V2X sidelink communication), a basic unit of resource configuration may be a subchannel. The subchannel may be defined with time and frequency resources. For example, the subchannel may be composed of a plurality of symbols (e.g., OFDM symbols) in the time domain, and may be composed of a plurality of resource blocks (RBs) in the frequency domain. The subchannel may be referred to as an RB set. In the subchannel, a data channel and a control channel may be multiplexed based on the option 3.

In the sidelink communication (e.g., NR-V2X sidelink communication), transmission resources may be allocated based on a mode 1 or a mode 2. When the mode 1 is used, a base station may allocate sidelink resource(s) for data transmission within a resource pool to a transmitting terminal, and the transmitting terminal may transmit data to a receiving terminal using the sidelink resource(s) allocated by the base station. Here, the transmitting terminal may be a terminal that transmits data in sidelink communication, and the receiving terminal may be a terminal that receives the data in sidelink communication.

When the mode 2 is used, a transmitting terminal may autonomously select sidelink resource(s) to be used for data transmission by performing a resource sensing operation and/or a resource selection operation within a resource pool. The base station may configure the resource pool for the mode 1 and the resource pool for the mode 2 to the terminal(s). The resource pool for the mode 1 may be configured independently from the resource pool for the mode 2. Alternatively, a common resource pool may be configured for the mode 1 and the mode 2.

When the mode 1 is used, the base station may schedule a resource used for sidelink data transmission to the transmitting terminal, and the transmitting terminal may transmit sidelink data to the receiving terminal by using the resource scheduled by the base station. Therefore, a resource conflict between terminals may be prevented. When the mode 2 is used, the transmitting terminal may select an arbitrary resource by performing a resource sensing operation and/or resource selection operation, and may transmit sidelink data by using the selected arbitrary resource. Since the above-described procedure is performed based on an individual resource sensing operation and/or resource selection operation of each transmitting terminal, a conflict between selected resources may occur.

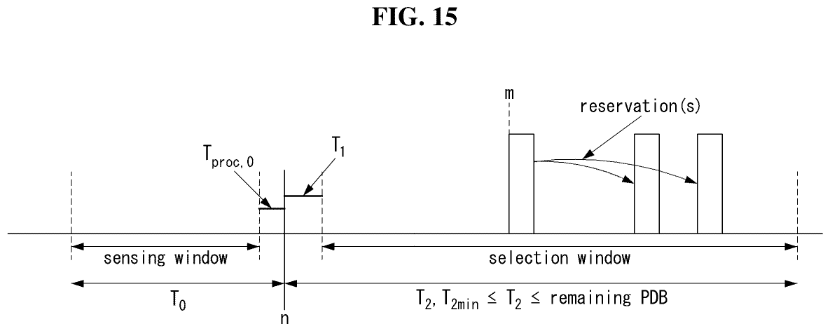

FIG. 15 is a conceptual diagram illustrating a first exemplary embodiment of a resource selection operation.

Referring to FIG. 15, a terminal (e.g., transmitting terminal) may perform a resource sensing operation within a sensing window, and may perform a resource selection operation on resource(s) (e.g., candidate resource(s)) sensed within the selection window. When the resource selection operation is triggered in a time n, the terminal may select suitable resource(s) within the selection window (e.g., a period from a time n+T₁ to a time n+T₂) based on a result of the sensing within the sensing window (e.g., a period from a time n-T₀ to a time n-T_{proc,0}).

Based on the result of the resource sensing operation, the terminal may exclude candidate resource(s) that do not satisfy a condition within the selection window. In other words, the terminal may determine the remaining candidate resources excluding the candidate resource(s) that are not suitable from all candidate resources. When a ratio of the remaining candidate resources among all resources within the selection window is less than a reference ratio, the terminal may relax the condition for excluding the candidate resource(s). For example, the terminal may increase a reference signal received power (RSRP) threshold, which is the condition for excluding candidate resource(s), by 3 dB. Thereafter, the terminal may perform the resource selection operation again. The reference ratio may be preset to one of 20%, 35%, or 50% for each priority. When the ratio of the remaining candidate resources is greater than or equal to the reference ratio, the terminal may randomly select final resource(s) to be used for SL transmission among the remaining candidate resources. The terminal may perform SL transmission using the final resource(s).

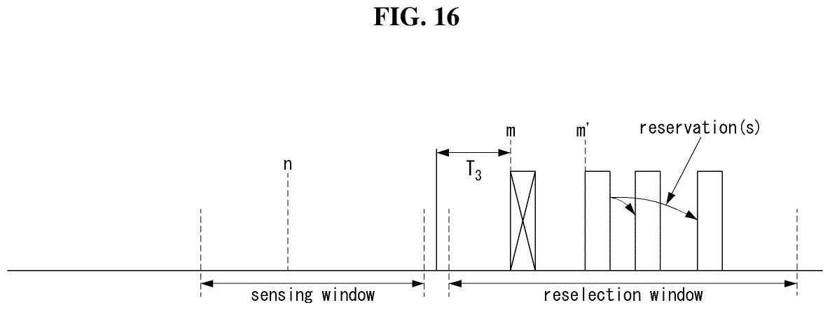

FIG. 16 is a conceptual diagram illustrating a first exemplary embodiment of a resource reselection operation.

Referring to FIG. 16, after the resource selection operation, the terminal may perform a resource reselection operation in consideration of aperiodic data transmission or the like. After performing the operations shown in FIG. 15, the terminal may perform the resource reselection operation by additionally considering a result of sensing at a time m-T₃ before actual SL transmission. The resource reselection operation may be performed within a reselection window. The terminal may further determine suitability of resource(s) reserved at the time m. When it is determined that the resource(s) reserved in the time m is suitable, the terminal may perform SL transmission using the reserved resource(s). When it is determined that the resource(s) reserved at the time m is not suitable, the terminal may reselect resource(s) for SL transmission and perform SL transmission using the reselected resource(s).

When an independent SL carrier is not configured for SL communication, some UL resources among UL resources may be configured as SL resources by an SL resource pool configuration procedure. A bitmap may be repeatedly applied to the remaining slot(s) excluding slot(s) in which at least X or more UL symbols are not configured and slot(s) in which a sidelink(S)-SSB is transmitted among slots within a specific period. X may be a natural number. The bitmap may indicate slot(s) used as SL resources. For example, slot(s) corresponding to bit(s) set to 1 among bits in the bitmap may be used as SL resources.

A case in which a 15 kHz subcarrier spacing (SCS) is applied and X or more UL symbols are configured in all slots may be assumed. When there are 10240 slots available within a direct frame number (DFN), a transmission periodicity of the S-SSB is 160 ms, and there are 2 slots used for S-SSB transmission in each S-SSB transmission period, the number of slots used for S-SSB transmission within a DFN may be 128. A bitmap for configuring SL time resources may include 10 bits. When the bitmap (e.g., bitmap including 10 bits) is repeatedly applied to the remaining 10112 slots excluding 128 slots used for S-SSB transmission among 10240 slots, there may be two slots (e.g., reserved slots) to which the bitmap is not applied. It may be necessary to exclude the two reserved slots. When excluding the two reserved slots from 10112 slots, 10110 slots may remain. The bitmap (e.g., bitmap including 10 bits) may be repeatedly applied 1011 times to 10110 slots. When the bitmap is set to ‘1111000000’ and slots corresponding to bits set to 1 are used as SL resources, 4044 slots may be configured as SL resources within the DFN. In other words, 4044 slots among 10240 slots may be used for SL communication by configuring the SL resource pool.

The sidelink communication system supporting Release-16 may be designed for terminals (e.g., vehicle-mounted terminals, vehicle UEs (V-UEs)) that do not have restrictions on battery capacity. Therefore, a power saving issue may not be greatly considered in resource sensing/selection operations for such the terminals. However, in order to perform sidelink communication with terminals having restrictions on battery capacity in the sidelink communication system supporting Release-17 (e.g., a terminal carried by a pedestrian, a terminal mounted on a bicycle, a terminal mounted on a motorcycle, a pedestrian UE (P-UE)), power saving methods will be required. In the present disclosure, a ‘V-UE’ may refer to a terminal that has no significant restrictions on battery capacity, a ‘P-UE’ may refer to a terminal with restrictions on battery capacity, and a ‘resource sensing/selection operation’ may refer to a resource sensing operation and/or a resource selection operation. The resource sensing operation may refer to a partial sensing operation or a full sensing operation. The resource selection operation may refer to a random selection operation. In addition, in the present disclosure, an ‘operation of a terminal’ may be interpreted as an ‘operation of a V-UE’ and/or ‘operation of a P-UE’.

For power saving in the LTE V2X, a partial sensing operation and/or a random selection operation has been introduced. When the partial sensing operation is supported, the terminal may perform resource sensing operations in partial periods instead of an entire period within a sensing window, and may select a resource based on a result of the partial sensing operation. According to such the operation, power consumption of the terminal may be reduced.

In the Release-14 LTE V2X, only periodic data transmission and reception operations may be possible. In the Release-14 LTE V2X, the terminal may arbitrarily select candidate slots within a resource selection period (e.g., selection window) in consideration of a preset minimum number, and perform a partial sensing operation in consideration of a periodicity of kx100 ms. k may be signaled by a bitmap (e.g., bitmap including 10 bits). k may be determined according to a position of a bit included in the bitmap. For example, 10 bits included in the bitmap may respectively correspond to values from 1 to 10 from the MSB, and the periodicity may be determined based on a value corresponding to a bit set to 1. The value corresponding to the bit set to 1 may be k.

When the MSB is set to 1 in the bitmap, k may be 1. In this case, the terminal may perform a partial sensing operation in consideration of a periodicity of 100 ms (=1×10⁰ ms). When a bit next to the MSB in the bitmap is set to 1, k may be 2. In this case, the terminal may perform a partial sensing operation in consideration of a periodicity of 200 ms (=2×10⁰ ms). When the LSB is set to 1 in the bitmap, k may be 10. In this case, the terminal may perform a partial sensing operation in consideration of a periodicity of 1000 ms (=10× 100 ms).

In the Release-14 LTE V2X, the periodicity (e.g., the periodicity of partial sensing operation) may be set to 20 ms or 50 ms. A periodicity of 20 ms or 50 ms may not be supported in a resource pool for a P-UE. In the NR communication system, a shorter periodicity may be supported in addition to {0, 100 ms, 200 ms, . . . , 1000 ms}. The short periodicity may be {1 ms, 2 ms, . . . , 99 ms}. Up to 16 periodicities may be selected from the resource pool, and the selected periodicities may be preconfigured to the terminal. The terminal may perform the resource sensing operation and/or the resource (re) selection operation using one or more of the configured periodicities. When a random selection operation is supported, the terminal may randomly select a resource without performing a resource sensing operation. Alternatively, the random selection operation may be performed together with the resource sensing operation. For example, the terminal may determine resources by performing the resource sensing operation, and may select resource(s) by performing the random selection operation within the determined resources.

In the LTE V2X supporting Release-14, a resource pool in which the partial sensing operation and/or random selection operation can be performed may be configured independently of a resource pool in which the full sensing operation can be performed. A resource pool capable of performing the random selection operation, a resource pool capable of performing the partial sensing operation, and a resource pool capable of performing the full sensing operation may be independently configured. In other words, a random selection operation, a partial sensing operation, or both a random selection operation and a partial sensing operation may be configured for each resource pool. When both a random selection operation and a partial sensing operation are configured for a resource pool, the terminal may select one operation among the random selection operation and the partial sensing operation, select a resource by performing the selected operation, and use the selected resource to perform SL communication.

In the LTE V2X supporting Release-14, sidelink (SL) data may be periodically transmitted based on a broadcast scheme. In the NR communication system, SL data may be transmitted based on a broadcast scheme, multicast scheme, groupcast scheme, or unicast scheme. In addition, in the NR communication system, SL data may be transmitted periodically or aperiodically. A transmitting terminal may transmit SL data to a receiving terminal, and the receiving terminal may transmit a HARQ feedback (e.g., acknowledgement (ACK) or negative ACK (NACK)) for the SL data to the transmitting terminal on a PSFCH. In the present disclosure, a transmitting terminal may refer to a terminal transmitting SL data, and a receiving terminal may refer to a terminal receiving the SL data.

A terminal having reduced capability (hereinafter, referred to as ‘RedCap terminal’) may operate in a specific usage environment. The capability of the RedCap terminal may be lower than capability of a new radio (NR) normal terminal, and may be higher than those of an LTE-machine type communication (LTE-MTC) terminal, a narrow band (NB)-Internet of things (IoT) terminal, and a low power wide area (LPWA) terminal. For example, a terminal (e.g., surveillance camera) requiring a high data rate and not high latency condition and/or a terminal (e.g., wearable device) requiring a non-high data rate, high latency condition, and high reliability may exist. In order to support the above-described terminals, the maximum carrier bandwidth in FR1 may be reduced from 100 MHz to 20 MHz, and the maximum carrier bandwidth in FR2 may be reduced from 400 MHz to 100 MHz. The number of reception antennas of the RedCap terminal may be smaller than the number of reception antennas of the NR normal terminal. When the carrier bandwidth and the number of reception antennas are reduced, reception performance at the RedCap terminal may decrease, and accordingly, the coverage of the RedCap terminal may decrease.

The communication system (e.g., NR system) may operate in a frequency band higher than a 52.6 GHz frequency band. As a frequency of the frequency band in which the communication system operates increases, a frequency offset error and a phase noise may increase. The use of a large SCS may be necessary for robust operations in such a environment. In an FR2 band, a 60 kHz SCS and/or a 120 kHz SCS may be supported, and a 480 kHz SCS and/or a 960 kHz SCS may be additionally supported. In addition, design of physical layer signals and channels and physical layer procedures according to the new SCSs may be required. Regarding an initial access procedure, 120 kHz SSBs and/or 240 kHz SSBs may be supported in an FR2 band, and 480 kHz SSBs and/or 960 kHz SSBs may be additionally supported. Here, the 120 kHz SSB may refer to an SSB transmitted in a radio resource to which the 120 kHz SCS is applied, and the 240 kHz SSB may refer to an SSB transmitted in a radio resource to which the 240 kHz SCS is applied. A method for configuring an initial BWP and an SSB burst set pattern for supporting the new SCSs may be required.

Duplex communication between communication nodes (e.g. base station and terminal) may be performed based on a half-duplex scheme or a full-duplex scheme. According to the half-duplex scheme, a communication node can perform only one of a signal transmission operation and a signal reception operation at one time. In other words, the communication node cannot perform transmission and reception operations simultaneously. According to the full-duplex scheme, a communication node can perform transmission and reception operations simultaneously or at different times. The full-duplex communication may be easily performed in a frequency division duplex (FDD) system (e.g. system using an FDD carrier, paired spectrum, etc.). A communication node may perform transmission and reception operations in separate frequency regions (e.g. uplink carrier and downlink carrier). Therefore, interference between signals in the separated frequency regions may be very small. On the other hand, even in a time division duplex (TDD) system (e.g. systems using a TDD carrier, unpaired spectrum, etc.), a communication node can perform transmission and reception operations within a common frequency region (e.g. carrier commonly used for uplink and downlink transmissions), and if the transmission operation and the reception operation are performed simultaneously, a transmission signal may interfere with a reception signal. Therefore, self-interference cancellation techniques may be required to perform full-duplex communication in a TDD system. The full-duplex communication in a TDD system may be referred to as in-band full-duplex communication. Meanwhile, the half-duplex communication may be easily performed in FDD systems and TDD systems because there is no interference problem described above.

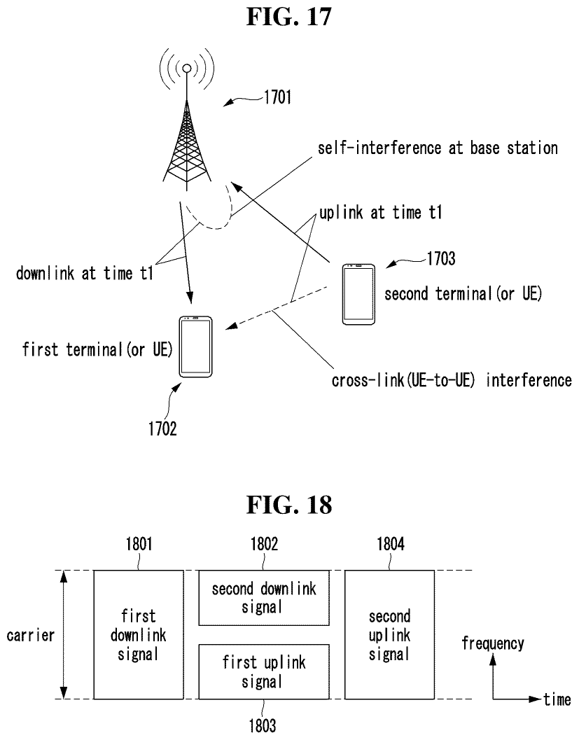

FIG. 17 is a conceptual diagram for describing in-band full-duplex communication.

Referring to FIG. 17, a base station 1701 may perform duplex communications with terminals 1702 and 1703 based on the full-duplex scheme. That is, the base station 1701 can perform transmission and reception operations at the same time. On the other hand, the terminals 1702 and 1703 can perform only one of a transmission operation and a reception operation at one time. For example, the base station 1701 may transmit a downlink signal to the first terminal 1702 at a time t1, and simultaneously receive an uplink signal from the second terminal 1703 at the time t1. The downlink signal and the uplink signal may be transmitted in the same band (e.g. within the same carrier). In this case, the downlink signal may act as self-interference in reception of the uplink signal by the base station. The base station can improve the reception performance of the uplink signal by cancelling or mitigating self-interference before detecting the uplink signal from a received signal.

In addition, the uplink signal transmitted by the second terminal 1703 may act as interference in reception of the downlink signal by the first terminal 1702. The interference between the uplink signal and downlink signal (e.g. uplink signal and downlink signal transmitted and received from different nodes (i.e. first terminal and second terminal)) may be referred to as cross-link interference. If a distance between the first terminal 1702 and the second terminal 1703 is close, or if a reception beam direction of the first terminal 1702 is similar to a transmission beam direction of the second terminal 1703, a strength of cross-link interference caused by the uplink signal to the downlink transmission may be large. Accordingly, the downlink signal reception performance of the first terminal 1702 may be deteriorated. In particular, if the first terminal 1702 does not have capability to cancel the cross-link interference, performance degradation may be more serious.

To solve the above-described cross-link interference problem between terminals, in the in-band full-duplex communication, the uplink signal and the downlink signal may be transmitted in different resource regions (e.g. time-frequency resource regions). For example, the uplink signal and the downlink signal transmitted in the same band (e.g. the same carrier) may be transmitted in different time resource regions. Alternatively, the uplink signal and the downlink signal transmitted in the same band (e.g. the same carrier) may be transmitted simultaneously (e.g. at the same time), and in this case, the uplink signal and the downlink signal may be transmitted in different frequency regions.

FIG. 18 is a conceptual diagram illustrating an exemplary embodiment to describe a method of multiplexing an uplink signal and a downlink signal in full-duplex communication.

Referring to FIG. 18, uplink signals and downlink signals within one serving cell (or carrier) may be transmitted as being multiplexed using different resources (e.g. different time-frequency resources). For example, a first downlink signal 1801, a second downlink signal 1802 (or a first uplink signal 1803), and a second uplink signal 1804 may be transmitted using different time resources (i.e. they may be time division multiplexed (TDMed)). As another example, the first uplink signal 1803 and the second downlink signal 1802 may be transmitted in the same time resource and different frequency resources (i.e. they may be frequency division multiplexed (FDMed)).

A base station may receive the uplink signals and transmit the downlink signals. For example, the base station may transmit the second downlink signal to a terminal (e.g. first terminal) and simultaneously receive the first uplink signal from another terminal (e.g. second terminal). In this case, the second downlink signal may act as self-interference (or cross-link interference) in reception of the first uplink signal by the base station. In addition, the first uplink signal may act as cross-link interference in reception of the second downlink signal by the first terminal. However, according to the present exemplary embodiment, the frequency region in which the first uplink signal is transmitted and the frequency region in which the second downlink signal is transmitted may be separated from each other, and if the frequency regions are sufficiently far apart, the above-mentioned cross-link interference may be alleviated. Here, the first terminal and the second terminal may be the first terminal 1702 and the second terminal 1703 illustrated in FIG. 17, respectively.

In the exemplary embodiment of FIG. 18, a time period in which simultaneous transmissions of the uplink signal and the downlink signal are allowed as described above may hereinafter be referred to as a sub-band full-duplex (SBFD) period.

In Rel-18, the beginning of 5G-Advanced, researches are being conducted on full-duplex communication schemes to increase spectrum efficiency, improve uplink performance, and reduce latency. More specifically, a base station can perform both a transmission operation and a reception operation simultaneously, while a terminal can only perform either a transmission operation or a reception operation at one time. A sub-band full-duplex (SBFD) communication scheme is being studied in which frequency resources for uplink and downlink communications are separated from each other in a time period where simultaneous transmission of uplink and downlink signals between the terminal and the base station is allowed.

As illustrated in FIG. 18, even when communication is performed using the SBFD scheme, the terminal may have no or insufficient capability to cancel cross-link interference compared to the base station. Additionally, in case of terminals of previous releases (i.e. existing terminals, legacy UEs) that do not support the SBFD scheme, they may not have capability to cancel cross-link interference at all. Accordingly, the present disclosure proposes an SBFD communication method that takes into account the cross-link interference cancellation capability of the terminal and coexistence with the existing terminals. More specifically, the present disclosure proposes an SBFD communication method in a time period (hereinafter, referred to as ‘synchronization signal block (SSB) time period’), during which SSB(s), one of important downlink signals, are transmitted.

The SSB is an important downlink signal that is subject to measurement for cell search, acquisition of time/frequency synchronization, cell reselection, and/or handover procedure during an initial access process. Therefore, not only legacy terminals but also terminals that support SBFD communication need to receive SSB(s) to perform the above-described operations. Therefore, in consideration of cross-link interference, etc., it may be preferable that a frequency region for SBFD communication (hereinafter referred to as ‘SBFD frequency region’) is configured so as not to overlap with a frequency region for SSB transmission (hereinafter referred to as ‘SSB frequency region’). However, considering resource efficiency, a time period for SBFD communication (hereinafter, referred to as ‘SBFD time period’) may be configured to overlap with a time period for SSB transmission and reception (hereinafter, referred to as ‘SSB time period’). Therefore, SBFD operations are required considering the case where the SBFD time period is configured to overlap with the SSB time period.

As described above, since SSBs are used not only during an initial access process but also for various measurements thereafter, the terminal may need to continuously monitor and measure SSBs. Therefore, for accurate measurement of the terminal, it may be preferable that cross-link interference does not occur in the SSB time period. To this end, if the SBFD time period overlaps with the SSB time period, SBFD operations may not be performed within the overlapping time period. More specifically, even when an uplink transmission within the SBFD frequency region is scheduled in the SBFD time period for the terminal supporting SBFD operations, if a time period for the uplink transmission overlaps with the SSB time period, the terminal may drop the uplink transmission without performing the uplink transmission. In this case, since cross-link interference due to SBFD operations does not occur in the SSB time period, measurement of SSBs can be performed more accurately. As described above, it may be generally preferable that the SBFD frequency region does not overlap with the SSB frequency region. However, exemplary embodiments proposed in the present disclosure may be applied even when the SBFD frequency region is configured to overlap with the SSB frequency region.

Even in case that SBFD operations are not performed in the SSB time period, whether to perform SBFD operations may be determined depending on whether SSB(s) are actually transmitted within the SSB time period. In the NR communication system, since some SSBs may not be actually transmitted within the SSB time period (e.g. SSB burst set) as described with reference to FIGS. 8 and 9, the terminal may determine whether to perform SBFD operations depending on whether SSB(s) are actually transmitted within the SSB time period overlapping the SBFD time period. More specifically, when the SSB time period overlaps with the SBFD time period, the terminal may not perform SBFD operations if SSB(s) are actually transmitted in the overlapping time period, and the terminal may perform SBFD operations if SSB(s) are not actually transmitted in the overlapping time period.

In the present disclosure, ‘SSB time period’ may basically refer to an SSB time period (e.g. SSB burst set) described with reference to FIGS. 8 and 9 and defined in the technical specifications. For example, the SSB time period may be understood as a concept corresponding to a half frame or a time period within a half frame where SSB(s) are transmitted, which is defined by the 3GPP technical specifications (e.g. TS38.213). In addition, when information on position(s) or section(s) where SSB(s) are actually transmitted within the SSB time period is indicated, ‘SSB time period’ in the present disclosure may be understood as position(s) or section(s) where SSB(s) are actually transmitted within the SSB burst set.

The information on the position(s) or section(s) where the SSB(s) are actually transmitted in candidate SSB positions within the SSB time period (e.g. SSB burst set) described with reference to FIGS. 8 and 9 may be indicated through RMSI and/or UE-specific RRC signaling (e.g. ssb-PositionsInBurst in ServingCellConfigCommonSIB or ServingCellConfigCommon). In some frequency bands (e.g. FR2), a signaling scheme through RMSI and UE-specific RRC signaling may vary (e.g. 16-bit signaling through RMSI and 64-bit signaling through UE-specific RRC signaling).

Therefore, the terminal may determine whether to apply the information depending on whether the information is obtained through RMSI or UE-specific RRC signaling. More specifically, if the information on whether SSB(s) are actually transmitted is obtained only through RMSI, the terminal may determine whether SSB(s) are actually transmitted within the SSB time period based on the information obtained through RMSI. If the information on whether SSB(s) are actually transmitted is obtained only through UE-specific RRC signaling, the terminal may determine whether SSB(s) are actually transmitted within the SSB time period based on the information obtained through UE-specific RRC signaling. However, when the information on whether SSB(s) are actually transmitted is received through RMSI and UE-specific RRC signaling, respectively, if the information received through RMSI and the information received through UE-specific RRC signaling are the same, the terminal may arbitrarily follow one of the information. On the other hand, if the information received through RMSI and the information received through UE-specific RRC signaling are different, it may be preferable for the terminal to follow the information through UE-specific RRC signaling that includes more detailed information.

In addition, information on an SSB transmission periodicity may be additionally considered. In general, SSB(s) for initial access may be transmitted with a basic periodicity of 20 ms, but the base station may set the SSB transmission periodicity within 5 to 160 ms by considering various environments. When a specific SSB transmission periodicity is additionally set, the terminal may determine whether to perform SBFD operations in the SSB transmission period by additionally considering the additionally-set SSB transmission periodicity. More specifically, when an additional SSB transmission periodicity is not set, it may be assumed that SSB(s) are transmitted at a periodicity of 20 ms, and the terminal may determine whether to perform SBFD operations by considering the transmission periodicity (i.e. 20 ms). When an SSB transmission periodicity other than 20 ms is set, the terminal may determine whether to perform SBFD operations by considering the set SSB transmission periodicity.

As described above, the terminal may not always perform SBFD operations in the SSB time period. Alternatively, the terminal may determine whether to perform SBFD operations depending on whether SSB(s) are actually transmitted in the SSB time period. The above-described operations may be selectively applied considering various system environments, and may be configured for each CC or BWP through system information or UE-specific RRC signaling.

Meanwhile, in the present disclosure, the ‘SSB time period’ may be determined based on configuration information of an SSB measurement window (e.g. SSB-based radio resource measurement (RRM) Measurement Timing Configuration (SMTC) window) received from the base station. Even in this case, position(s) or section(s) where SSB(s) are actually transmitted determined based on the information on the position(s) or section(s) where SSB(s) are actually transmitted, which is indicated to the terminal through RMSI and/or UE-specific RRC signaling, may be interpreted as ‘SSB time period’.

As described above, if SBFD operations are not performed in all SSB time periods or if SBFD operations are not performed only in some SSB time periods depending on the configuration (e.g. SSB measurement window and/or whether SSB(s) are actually transmitted), a gain obtainable from supporting SBFD operations, such as improved uplink coverage and reduced latency, may not be significant due to frequent constraints on SBFD operations during the SSB time periods.

Therefore, even if an SSB time period and an SBFD time period overlap, it may be preferable in terms of resource efficiency to support SBFD operations in the overlapping time period. In this case, it may be preferable to minimize cross-link interference that may affect other terminals performing measurements on SSBs. Hereinafter, methods for reducing cross-link interference generated by SBFD operations will be described as other exemplary embodiments of the present disclosure.

In general, in order to reduce cross-link interference caused by SBFD operations, a guard band may be configured when configuring frequency region resources for SBFD operations.

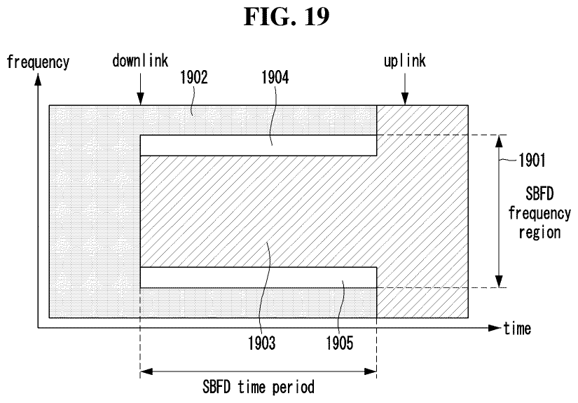

FIG. 19 is a conceptual diagram illustrating configuration of frequency regions for SBFD operations according to an exemplary embodiment of the present disclosure.

Referring to FIG. 19, in order to reduce cross-link interference between a downlink frequency resource and an uplink frequency resource configured in a frequency region 1901 for SBFD operations, guard bands may be configured around the uplink frequency resource. In the exemplary embodiment of FIG. 19, the SBFD frequency region 1901 is illustrated as including only an uplink resource 1903 and guard bands 1904 and 1905, but the SBFD frequency region may be defined as a region including downlink resources, guard bands, and uplink resources. When the SBFD frequency region is configured, cross-link interference caused by an uplink transmission of an SBFD-supporting terminal using the uplink resource in the SBFD frequency region, which affects downlink receptions of other terminals, may be reduced by configuring appropriate guard bands.

As described above, even when SBFD operations are performed in the SSB time period, the impact on the SSB measurement performance of other terminals can be reduced through guard band(s). However, since reception of SSB(s) is more important than reception of other downlink signals, in order to further reduce cross-link interference, a guard band configured in an SBFD frequency region within an SBFD time period that overlaps with an SSB time period may have a wider bandwidth than a guard band configured in an SBFD frequency region within an SBFD time period that does not overlap the SSB time period.

Each guard band may be configured with a start resource block (RB) index thereof and the number of RBs included in each guard band (or a start RB index and an end RB index).

Therefore, if a general guard band (e.g. a guard band configured in an SBFD frequency region within an SBFD time period that does not overlap with an SSB time period) is configured to include M RBs, a guard band configured in an SBFD frequency region within an SBFD time period overlapping with an SSB time period may be configured to include N (>M) RBs.

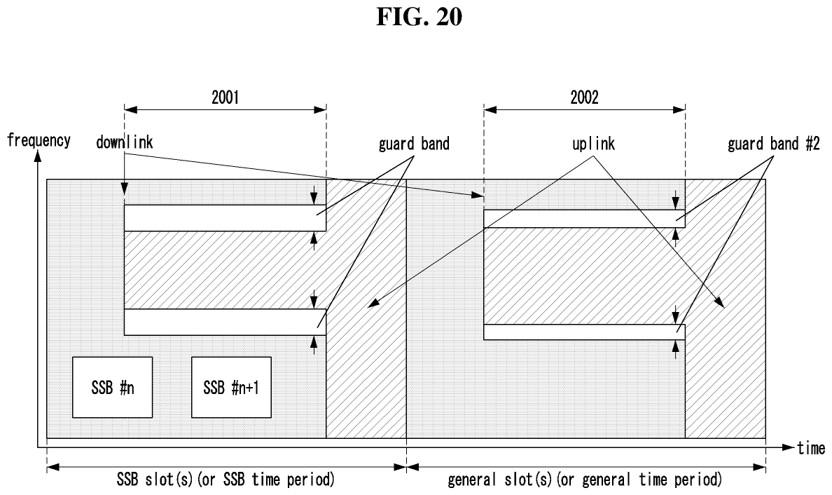

FIG. 20 is a conceptual diagram for describing a case where guard bands of different widths are configured in an SSB time period and a general time period according to an exemplary embodiment of the present disclosure.

Referring to FIG. 20, a guard band (e.g. guard band #1) configured in a time period 2001 where an SBFD time period and an SSB time period overlap may be configured to have a larger bandwidth than a guard band (e.g. guard band #2) configured in a general time period 2002. Therefore, the guard band configured when the SSB time period and the SBFD time period overlap may relatively reduce the impact of cross-link interference on downlink receptions. As described above, the guard band considering the SSB time period may be configured and applied based on slot(s) in which SSB(s) are transmitted, or may be configured and applied based on symbol(s) in which SSB(s) are transmitted, as shown in FIG. 20.

As described above, when the guard bands for SBFD operations are configured differently in the SSB time period and the general time period, it may be preferable for the base station to perform appropriate uplink scheduling considering them. However, in case of configured grant (CG) scheduling or even in case of dynamic grant (DG) scheduling performed without considering the different guard bands, uplink transmission methods of the terminal considering them are needed.

More specifically, if an uplink resource scheduled (allocated) to the terminal for uplink transmission belongs to an uplink resource of an SBFD frequency region in a general time period, but belongs to a guard band of an SBFD frequency region in an SSB time period, the terminal may perform the uplink transmission using the scheduled uplink resource in the general time period. On the other hand, the terminal may drop the uplink transmission in the SSB time period or perform the uplink transmission using only a remaining uplink resource excluding a frequency resource belonging to the guard band from the allocated uplink resource. In the latter case, the terminal may perform puncturing or rate matching on data mapped to the uplink resource belonging to the guard band. If an uplink resource scheduled (allocated) to the terminal for uplink transmission belongs to a guard band of an SBFD frequency region in a general time period, the terminal may drop the uplink transmission even in the general time period or perform the uplink transmission using only a remaining uplink resource excluding a frequency resource belonging to the guard band from the allocated uplink resource. In the latter case, the terminal may perform puncturing or rate-matching on data mapped to the uplink resource belonging to the guard band.

Meanwhile, when guard band(s) are configured only in symbol(s) where SSB(s) are transmitted, a width of the guard band may vary even within one slot. In this case, the terminal may perform uplink transmission considering only a large guard band (i.e. guard band configured for the symbol(s) where SSB(s) are transmitted), or perform uplink transmission according to scheduling, but perform puncturing or rate matching for data mapped to an uplink resource belonging to a region of the large guard band.

In another exemplary embodiment, in addition to the method of configuring sizes of guard bands for SBFD operations differently in an SSB time period and a general time period (i.e. time period in which reception of downlink signals excluding SSB is performed or transmission of uplink signals is performed), a method of applying different UL transmission powers to SBFD operations in the SSB time section and the general time period may be used. More specifically, in order to reduce the impact of cross-link interference on measurements of SSBs, it may be preferable that a UL transmission power for SBFD operations performed in the SSB time period is set to be lower than a UL transmission power for SBFD operations in a general time period (i.e. the existing time period that does not support SBFD operations and/or a time period in which SBFD operations are not performed in position(s) and section(s) where SSB(s) are actually transmitted within the SSB time period).

Therefore, a separate uplink (UL) power control may be performed for this purpose. When the separate UL power control is performed, parameters therefor may be set separately. The parameters may include P₀, which is the maximum transmission power value, α, which is a path-loss compensation factor, and P_{L}, which is a path-loss estimation value. In addition, a value Δ associated with a modulation and coding (MCS) scheme and an accumulation function for power control may also be set separately.

In the SSB time period, SBFD operations (i.e. UL transmission operations) may be applied dynamically or semi-statically. The base station may dynamically or semi-statically signal to the terminal whether the terminal supports SBFD operations based on cross-link interference obtained by a measurement process, information on uplink beam(s), location information of the terminal, etc. DCI (e.g. 1 bit indication) may be used as dynamic signaling, and a MAC CE or RRC signaling may be used as semi-static signaling.

As another method, the terminal may determine whether to support SBFD operations according to a priority of SSB reception operations without additional signaling. For example, even if SBFD operations are configured to be supported in the SSB time period, uplink transmission according to the SBFD operation may be dropped according to high-priority SSB reception operations (e.g. measurement for initial access or cell reselection, etc.), and only the SSB reception operations may be performed. Alternatively, in case of high priority uplink transmission (e.g. URLLC transmission), the uplink transmission may be performed based on the SBFD operation regardless of the SSB transmission period.

As another method, a list of transmission configuration indicators (TCIs) or a list of SRS resource indicators (SRIs) that are prohibited in the SSB time period may be signaled to the terminal. The terminal may consider the remaining TCIs (or SRIs) in a UL TCI pool (or SRI pool) that are not included in the list of TCIs or SRIs prohibited in the SSB transmission period as valid TCIs (or SRIs), and may perform only an uplink transmission to which the valid TCI(s) or SRI(s) is applied in the SSB time period. More specifically, when uplink scheduling information received by the terminal includes indication information of TCI(s) (or SRI(s)), or when CG configuration information for scheduled uplink transmission includes indication information of TCI(s) (or SRI(s)), the terminal may perform scheduled uplink transmission in an SSB time period if the indication information indicates valid TCI(s) (or SRI(s)).

As described above, in order to cancel or reduce the impact of cross-link interference in various procedures and measurement processes through SSBs, even if SBFD operations are not supported in the SSB time period or SBFD operations are supported in the SSB time period, it may be preferable to configure a larger guard band for SBFD operations performed in the SSB time period. Additionally or alternatively, separate power control may be applied for the SBFD operations performed in the SSB time period. In addition, whether to support SBFD operations may be configured dynamically or semi-statically through signaling.

The SSBs may be classified into cell-defining (CD)-SSBs, which are used in cell search and initial access processes, and non-cell-defining (NCD)-SSBs, which are mainly used for time/frequency synchronization and measurement purposes. Since the CD-SSBs are essential during cell search and initial access processes, reception and measurement of CD-SSBs may be more important than those of NCD-SSBs. Therefore, SBFD operations that are not supported regardless of distinction between CD-SSBs and NCD-SSBs, configuration of a guard band having a different size (e.g. larger size) from a guard band of a general time period or application of a separate power control regardless of distinction between CD-SSBs and NCD-SSBs, configuration of whether to support dynamic or semi-static SBFD operations regardless of distinction between CD-SSBs and NCD-SSBs, and the like may not be preferable in terms of resource efficiency. Therefore, it may be preferable to apply whether SBFD operations are supported and SBFD resource configurations differently depending on a CD-SSB time period or NCD-SSB time period.

More specifically, SBFD operations may not be supported in a CD-SSB time period, and SBFD operations may be supported only in an NCD-SSB time period. For the SBFD operations performed in the NCD-SSB time period, it may be configured whether to configure large guard band(s), whether to apply separate power control, and/or whether to support dynamic or semi-static SBFD operations. For example, for the NCD-SSB time period, guard band(s) having the same bandwidth as the general time period may be applied, the same power control as the general time period may be applied, or dynamic or semi-static SBFD operations may not be supported.

The above-described exemplary embodiments have described SBFD communication methods considering SSBs, but the SBFD communication methods described in the above-described exemplary embodiments may be applied also to a PDCCH transmitted in a type 0 PDCCH CSS, which is transmitted in one-to-one mapping with a CD-SSB, and an RMSI PDSCH that is scheduled through the PDCCH.

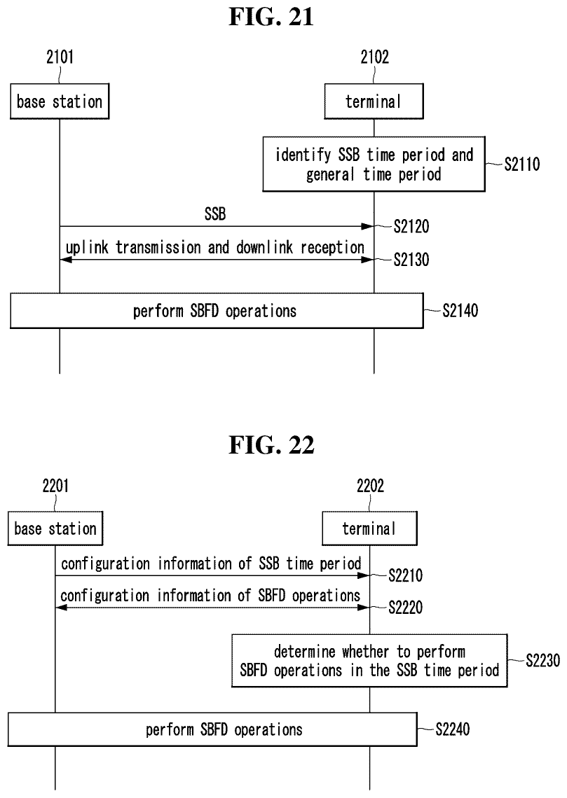

Hereinafter, exemplary embodiments according to the present disclosure will be described in more detail. FIG. 21, to be described later, may correspond to an exemplary embodiment of an SBFD operation considering SSB transmission in an initial access process, and FIG. 22, to be described later, may correspond to an exemplary embodiment of an SBFD operation considering SSB transmission in an SSB measurement process.

FIG. 21 is a sequence chart for describing a method of performing an SBFD operation considering SSB transmission according to an exemplary embodiment of the present disclosure.

Referring to FIG. 21, a terminal 2102 may identify an SSB time period for SSB reception or measurement and a general time period other than the SSB time period (S2110). Here, the SSB time period may be predefined by technical specifications (e.g. SSB burst set described with reference to FIGS. 8 and 9), or may be determined as position(s) or section(s) where SSB(s) are actually transmitted within the SSB burst set or an SMTC window identified through RMSI and/or UE-specific signaling received from the base station.

Then, the terminal may receive or measure at least one SSB from the base station 2101 in the SSB time period (S2120), and transmit at least one uplink signal or receive at least one downlink signal in the general time period (S2130).

In FIG. 21, it is illustrated that the terminal 2102 receives SSB(s) from the base station 2101 after performing the step S2110 of identifying the SSB time period and the general time period. However, the terminal 2102 may attempt to receive SSB(s) during an initial access process and identify the SSB time period based on the received SSB(s). In other words, since the terminal 2102 may not know the existence of SSB(s) before performing the initial access process, the terminal 2102 may identify the SSB time period through reception of the SSB(s), and identify time periods other than the identified SSB time period as general time periods.

The terminal 2102 and the base station 2101 may perform SBFD operations in the SSB time period and the general time period, or may perform SBFD operations only in the general time period without performing SBFD operations in the SSB time period (S2140).

Meanwhile, when SBFD operations are performed in the SSB time period, a first guard band for SBFD operations applied to the SSB time period and a second guard band for SBFD operations applied to the general time period may be configured separately. That is, the first guard band and the second guard band may be defined by separate parameters (or equations), or may be defined by one of the first guard band and the second guard band and an offset between the first guard band and the second guard band. For example, the first guard band for SBFD operations applied to the SSB time period may be configured to have a wider bandwidth than the second guard band for SBFD operations applied to the general time period.

Meanwhile, when SBFD operations are performed in the SSB time period, an uplink transmission power (first transmission power) for SBFD operations applied to the SSB time period and an uplink transmission power (second transmission power) for SBFD operations applied to the general time period may be set separately. That is, the first transmission power and the second transmission power may be defined by separate parameters (or equations), or may be defined by one of the first transmission power and the second transmission power and an offset between the first transmission power and the second transmission power. For example, the first transmission power may be set to have a lower value than the second transmission power.

In addition, the terminal 2102 may additionally receive a list including at least one TCI or SRI that is prohibited in the SSB time period from the base station 2101. In this case, if SBFD operations are performed in the SSB time period, the terminal 2102 may not perform uplink transmission to which the at least one TCI or SRI is applied during the SSB time period.

The SSB time period may be classified into a CD-SSB time period in which CD-SSB(s) are transmitted and/or an NCD-SSB time period in which NCD-SSB(s) are transmitted. When SBFD operations are performed in the SSB time period, a first guard band for SBFD operations applied to the CD-SSB time period and a second guard band for SBFD operations applied to the NCD-SSB time period may be configured separately. Additionally or alternatively, an uplink transmission power (i.e. first transmission power) for SBFD operations applied to the CD-SSB time period and an uplink transmission power (i.e. second transmission power) for SBFD operations applied to the NCD-SSB time period may be set separately. In this case as well, configuration of the first guard band and the second guard band and configuration of the first transmission power and second transmission power may be performed as described above.

FIG. 22 is a sequence chart for describing a method of performing an SBFD operation considering SSB transmission according to another exemplary embodiment of the present disclosure.

Referring to FIG. 22, a terminal 2202 may receive configuration information of an SSB time period for SSB reception or measurement from a base station 2201 (S2210). In this case, the configuration information of the SSB time period may be received as SSB measurement window configuration information, or may be received based on the SSB measurement window configuration information and RMSI and/or UE-specific RRC signaling. The SSB time period may be determined as an SSB measurement window indicated by the SSB measurement window configuration information, or may be determined as position(s) or section(s) where SSB(s) are actually transmitted within the SSB measurement window, indicated through RMSI and/or UE-specific signaling.

In addition, the terminal 2202 may receive configuration information for SBFD operations of the terminal from the base station 2201 (S2220). For example, the configuration information for SBFD operations may include resource configuration for SBFD operations (described with reference to FIGS. 19 and 20) and/or information indicating whether to perform SBFD operations. Meanwhile, if the configuration information for SBFD operations is predefined by the technical specifications or the configuration information has already been delivered to the terminal as information in another form, the step S2220 may be omitted. In addition, before the step S2220, the terminal 2202 may report capability information indicating that the terminal 2202 has capabilities to support SBFD operations to the base station 2201. It should be noted that such procedure is omitted in FIG. 22 for convenience of description. In addition, in FIG. 22, the step S2220 is illustrated as being performed after the step S2210, but the step S2220 may be performed before or simultaneously with the step S2210.

Then, the terminal 2202 may determine whether to perform SBFD operations in the SSB time period (S2230), and if it is determined to perform SBFD operations in the SSB time period, the terminal may perform SBFD operations with the base station 2201 in the SSB time period (S2240).

If SBFD operations are performed in the SSB time period, first guard band(s) may be configured around an uplink resource belonging to a frequency region for performing SBFD operations within the SSB time period. A bandwidth of the first guard band(s) and a bandwidth of second guard band(s) configured around an uplink resource belonging to a frequency region for performing SBFD operations in a general time period that does not overlap with the SSB time period may be set separately. That is, the first guard band and the second guard band may be defined by separate parameters (or equations), or may be defined by one of the first guard band and the second guard band and an offset between the first guard band and the second guard band. For example, the first guard band for SBFD operations applied to the SSB time period may be configured to have a wider bandwidth than the second guard band for SBFD operations applied to the general time period.

When an uplink transmission is scheduled through an uplink resource including the first guard band(s), the terminal may drop the uplink transmission or may perform the uplink transmission by using a resource excluding a resource belonging to the first guard band(s) from the uplink resource. When the uplink transmission is performed in a resource other than the resource belonging to the first guard band(s) from the uplink resource, the terminal may perform puncturing or rate-matching on uplink transmission data mapped to the resource belonging to the first guard band(s).

When SBFD operations are performed in the SSB time period, a transmission power (hereinafter, first transmission power) applied to uplink resources belonging to a frequency region for performing SBFD operations within the SSB time period and a transmission power (hereinafter, second transmission power) applied to uplink resources belonging to a frequency region for performing SBFD operations in a general time period that does not overlap with the SBFD time period may be set separately. That is, the first transmission power and the second transmission power may be defined by separate parameters (or formulas), or may be defined by one of the first transmission power and the second transmission power and an offset between the first transmission power and the second transmission power. For example, the first transmission power may be set to have a lower value than the second transmission power.

Meanwhile, the terminal 2202 may additionally receive from the base station 2201 a list including at least one TCI or SRI that is prohibited in the SSB time period. In this case, when SBFD operations are performed in the SSB time period, the terminal 2202 may not perform uplink transmission to which the at least one TCI or SRI is applied during the SSB time period.

The SSB time period may be classified into a CD-SSB time period in which CD-SSB(s) are transmitted and/or an NCD-SSB time period in which NCD-SSB(s) are transmitted. When SBFD operations are performed in the SSB time period, a first guard band for SBFD operations applied to the CD-SSB time period and a second guard band for SBFD operations applied to the NCD-SSB time period may be configured separately. Additionally or alternatively, an uplink transmission power (i.e. first transmission power) for SBFD operations applied to the CD-SSB time period and an uplink transmission power (i.e. second transmission power) for SBFD operations applied to the NCD-SSB time period may be set separately. In this case as well, configuration of the first guard band and the second guard band and configuration of the first transmission power and second transmission power may be performed as described above.

Meanwhile, in another exemplary embodiment, a terminal supporting SBFD operations may receive configuration information of an additional SSB measurement window (i.e. second SSB measurement window) for determining whether to perform SBFD operations, in addition to configuration information of a general SSB measurement window (i.e. first SSB measurement window). For example, the terminal may be configured with a separate SSB measurement window (e.g. SMTC window) for SBFD operations from the base station through SSB-MTC (e.g., SSB-MRC5). In this case, the terminal may perform measurement on SSB(s) only within the separately configured second SSB measurement window.

In addition, even within the separately configured second SSB measurement window, the terminal may determine whether to perform SBFD operations based on whether SSB(s) are actually transmitted, and may perform SBFD operations during sections in which SSB(s) are not actually transmitted. In this case, as described above, information on position(s) and section(s) where SSB(s) are not actually transmitted may be determined based on the parameter ssb-PositionsInBurst received from the base station through RMSI and/or UE-specific RRC signaling.

In addition, in other SSB time periods (i.e. time periods that belong to the first SSB measurement window but do not belong to the second SSB measurement window), the terminal may perform SBFD operations regardless of whether SSB(s) are actually transmitted.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a terminal, comprising:
identifying a synchronization signal block (SSB) time period for SSB reception or measurement and a general time period other than the SSB time period;
receiving or measuring at least one SSB in the SSB time period; and
transmitting at least one uplink signal or receiving at least one downlink signal in the general time period,
wherein a subband full-duplex (SBFD) operation is performed in the SSB time period and the general time period, or the SBFD operation is not performed in the SSB time period and the SBFD operation is performed only in the general time period.

2. The method according to claim 1, wherein the SSB time period is determined as an SSB burst set predefined by technical specifications, or is determined as position(s) or section(s) where SSB(s) are actually transmitted within the SSB burst set or an SSB-based radio resource measurement (RRM) Measurement Timing Configuration (SMTC) window identified through remaining system information (RMSI) and/or user equipment (UE)-specific radio resource control (RRC) signaling received from the base station.

3. The method according to claim 1, wherein when SBFD operations are performed in the SSB time period, a first guard band for the SBFD operations applied to the SSB time period is configured separately from a second guard band for the SBFD operations applied to the general time period.

4. The method according to claim 1, wherein when SBFD operations are performed in the SSB time period, an uplink transmission power for the SBFD operations applied to the SSB time period is set separately from an uplink transmission power for the SBFD operations applied to the general time period.

5. The method according to claim 1, further comprising: receiving from the base station a list including at least one Transmission Configuration Indicator (TCI) or sounding reference signal (SRS) resource indicator (SRI) that is prohibited in the SSB time period,
wherein when SBFD operations are performed in the SSB time period, the terminal does not perform uplink transmission to which the at least one TCI or SRI is applied during the SSB time period.

6. The method according to claim 1, wherein when the SSB time period is classified into a cell defining (CD)-SSB time period in which CD-SSB(s) are transmitted and/or a non-cell-defining (NCD)-SSB time period in which NCD-SSB(s) are transmitted, and SBFD operations are performed in the SSB time period, a first guard band for the SBFD operations applied to the CD-SSB time period is configured separately from a second guard band for the SBFD operations applied to the NCD-SSB time period, or an uplink transmission power for the SBFD operations applied to the CD-SSB time period is set separately from an uplink transmission power for the SBFD operations applied to the NCD-SSB time period.

7. A method of a terminal, comprising:
receiving, from a base station, configuration information of a synchronization signal block (SSB) time period for SSB reception or measurement;
receiving configuration information of subband full-duplex (SBFD) operations from the base station;
determining whether to perform the SBFD operation in the SSB time period; and
in response to determining to perform the SBFD operation in the SSB time period, performing the SBFD operation in the SSB time period.

8. The method according to claim 7, wherein the configuration information of the SSB time period is received as SSB measurement window configuration information, or is received based on the SSB measurement window configuration information and remaining system information (RMSI) and/or user equipment (UE)-specific radio resource control (RRC) signaling, the SSB time period is determined as an SSB measurement window indicated by the SSB measurement window configuration information, or position(s) or section(s) where SSB(s) are actually transmitted within the SSB measurement window, which are identified through the RMSI and/or UE-specific RRC signaling.

9. The method according to claim 7, further comprising performing the SBFD operation in a general time period other than the SSB time period.

10. The method according to claim 7, wherein when the SBFD operation is performed in the SSB time period, first guard band(s) are configured around an uplink resource belonging to a frequency region for performing the SBFD operation within the SSB time period.

11. The method according to claim 10, wherein a bandwidth of the first guard band(s) is set separately from a bandwidth of second guard band(s) configured around an uplink resource belonging to a frequency region for performing the SBFD operation in a general time period that does not overlap with the SSB time period.

12. The method according to claim 10, wherein when an uplink transmission through an uplink resource including the first guard band(s) is scheduled, the terminal drops the uplink transmission or performs the uplink transmission using a resource excluding a resource belonging to the first guard band(s) from the uplink resource.

13. The method according to claim 12, wherein when the uplink transmission is performed in the resource excluding the resource belonging to the first guard band(s) from the uplink resource, the terminal performs puncturing or rate-matching for uplink transmission data mapped to the resource belonging to the first guard band(s).

14. The method according to claim 7, wherein when the SBFD operation is performed in the SSB time period, a transmission power applied to an uplink resource belonging to a frequency region for performing the SBFD operation within the SSB time period is set separately from a transmission power applied to an uplink resource belonging to a frequency region for performing the SBFD operation within a general time period that does not overlap the SSB time period.

15. The method according to claim 7, further comprising: receiving from the base station a list including at least one Transmission Configuration Indicator (TCI) or sounding reference signal (SRS) resource indicator (SRI) that is prohibited in the SSB time period,
wherein when SBFD operations are performed in the SSB time period, the terminal does not perform uplink transmission to which the at least one TCI or SRI is applied during the SSB time period.

16. The method according to claim 7, wherein when the SSB time period is classified into a cell defining (CD)-SSB time period in which CD-SSB(s) are transmitted and/or a non-cell-defining (NCD)-SSB time period in which NCD-SSB(s) are transmitted, and SBFD operations are performed in the SSB time period, a first guard band for the SBFD operations applied to the CD-SSB time period is configured separately from a second guard band for the SBFD operations applied to the NCD-SSB time period, or an uplink transmission power for the SBFD operations applied to the CD-SSB time period is set separately from an uplink transmission power for the SBFD operations applied to the NCD-SSB time period.

17. A method of a terminal, comprising:
receiving configuration information of a first synchronization signal block (SSB) measurement window from a base station;
receiving configuration information of subband full-duplex (SBFD) operations from the base station;
receiving configuration information of a second SSB measurement window from the base station;
performing a measurement operation for SSB(s) in a first SSB time period belonging to the second SSB measurement window; and
performing the SBFD operation in a time period that belongs to the first SSB measurement window and does not belong to the second SSB measurement window.

18. The method according to claim 17, wherein each of the configuration information of the first SSB measurement window and the configuration information of the second SSB measurement window is configuration information of an SSB-based radio resource measurement (RRM) Measurement Timing Configuration (SMTC) window.

19. The method according to claim 17, further comprising: determining whether to perform the SBFD operation in the first SSB time period,
wherein the determining of whether to perform the SBFD operation in the first SSB time period comprises:
receiving, from the base station, information on position(s) where SSB(s) are actually transmitted among candidate SSB positions within the first SSB time period;
determining to perform the SBFD operation at position(s) other than the position(s) where SSB(s) are actually transmitted among the candidate SSB positions within the first SSB time period; and
in response to determining to perform the SBFD operation in the first SSB time period, performing the SBFD operation in the first SSB time period.

20. The method according to claim 19, wherein the information on the position(s) where SSB(s) are actually transmitted among the candidate SSB positions within the first SSB time period is a parameter ssb-PositionsInBurst received from the base station through remaining system information (RMSI) and/or user equipment (UE)-specific radio resource control (RRC) signaling.
